(19) United States
(12) Patent Application Publication
(10) Pub. No.: US 2003/0177289 A1
(43) Pub. Date: Sep. 18, 2003

(54) Method, device and program for input prediction processing, and recording medium for recording program thereof

(75) Inventors: Minoru Wakatsuki, Nagaoka (JP); Masaki Suenaga, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/331,954

(22) Filed: Dec. 31, 2002

(30) Foreign Application Priority Data
Jan. 11, 2002 (JP) 2002-004823

(51) Int. Cl. G06F 3/00

(52) U.S. Cl. 710/1

(57) ABSTRACT

In the present invention, a reading r and an expression e entered by an input unit are stored as history data. When a subsequent reading is entered thereafter, an input reading R1 is keystroke converted to input-reading keystrokes K1. The history data is also read, and the reading r is set as history-data reading keystrokes K2 and the expression e is set as an expression E1. A comparison is made between the data string of the input-reading keystrokes K1 and the data string of the history-data reading keystrokes K2. If they are forward-matched, the expression E1 is adopted and output as a candidate.

### BACKGROUND OF THE INVENTION

1. Field of the Invention

The present invention relates to an input prediction processing technique. More particularly, the present invention relates to an input prediction processing technique in which previously input character strings are stored as history data, and candidate expressions are displayed based on the stored history data when the same characters are entered next time into a character-input unit having a numeric keypad, such as a computer, a personal digital assistant, a mobile phone, a pocket beeper, a car-navigation system, and so on.

2. Description of the Related Art

In order to reduce the workload for a user input operation and a conversion operation, input prediction processing is performed before the characters, entered by their reading (phonetic pronunciation), are determined. Reading, here, means a character string representing the reading (phonetic pronunciation) of characters which need to be converted.

Input prediction processing is performed based on history data, that is, the character strings entered so far, by obtaining and displaying history data having a forward-matched reading as an input prediction candidate during the next input of a reading. For this input prediction processing, conventionally, a comparison is made between a reading being input and character codes of readings in the history data.

In Japanese Unexamined Patent Application Publication No. 08-314920, “Character input unit”, a description is given of a character input unit in which, when a key to which a plurality of characters are assigned is operated, and then a conversion/next candidate key is operated, a candidate character or character string found for the character corresponding to the input keys is sent to output means. In the conventional input prediction processing, character codes are used for searching for a character candidate (input prediction candidate) of an input character to be predicted. Thus, in order for the input prediction processing to function properly, a predetermined number of characters for the target of the input prediction processing need to be entered.

However, in a character input unit having a few keys, wherein a plurality of characters are assigned to one key, it becomes necessary to perform operations such as pressing the same key a plurality of times before a certain character is entered.

FIG. 44 illustrates an example of a general terminal device provided with an input unit 2 having a small number of keys, each of which has a plurality of characters assigned thereto. In a terminal device, such as a mobile phone, etc., a plurality of Kana (Japanese syllabary) characters and alphabetic characters, etc. are generally assigned to one numeric key. In the input unit 2 shown in FIG. 44, five Kana characters of each row of the Japanese syllabary and three to four alphabetic characters are assigned to each of the ten numeric keys. In the input unit 2, a key is pressed one time or a plurality of times to enter a reading, and then by character-input processing, for example, Kanji (Chinese character) conversion processing, a desired expression is obtained. For example, when entering the reading “sumou” in order to obtain an expression “SUMOU (Kanji)” by the input unit 2, it is necessary to enter “33377777111” (Here, lower case letters correspond to Kana (Japanese syllabary) and upper case letters correspond to Kanji (Chinese character)).

Suppose that, in reading (character) input processing using an input unit having a few input keys, input prediction processing, which selects words from history data to display input candidates, is started when two characters of a reading are entered. In this case, the number of times the numeric keys are pressed for a reading “sumo” is eight (“33377777”), and thus the number of times for key operations is not reduced much as compared with the case of usual input processing which does not use input prediction processing. As just described, in the conventional input prediction processing using character codes, the number of key operations until reaching the input prediction target is large, depending on the input reading, and thus an advantage of reducing the operation work required by the user cannot be obtained.

Suppose that the above-described Japanese Unexamined Patent Application Publication No. 08-314920, “Character input unit” is applied to the case where a previous input reading is predicted and displayed as an input candidate at the start of a next input. For example, if “41” is entered by an input key operation, this input unit outputs candidates which belong to “any character in the “ta” row of the Japanese syllabary”. This means that when “41” is entered using the input keys, both the word “Tokyo” which begins with the reading “to” and the word “teikyou” which begins with the reading “te” are selected and displayed as candidates. Accordingly, too many candidates are displayed, and the processing for selecting from the candidates means even more work for the user. Thus there is a shortcoming in that input operation workload is not reduced.

### SUMMARY OF THE INVENTION

Accordingly, it is an object of the present invention to provide an input prediction processing device which can reduce the number of key-input operations for displaying input prediction candidates in an input unit using input keys having a plurality of assigned characters.

According to the present invention, there is provided an input prediction processing method for causing a computer to execute input prediction processing, wherein the computer includes a history-data storage unit for storing previously input reading and expression and displays an expression corresponding to a reading extracted from the history-data storage unit when a reading is entered next time.

In the present invention, reading keystroke information representing an input reading by a keystroke data string as history-data reading is stored in the history-data storage unit. When a next reading is entered, input-reading keystroke information representing an input keystroke data string from the reading is obtained, and when the input-reading keystroke information matches a beginning part of the history data reading, the expression corresponding to the history data reading is selected as an input prediction candidate.

Also, in the present invention, an input reading character string is stored as history-data reading in the history-data storage unit. When a next reading is entered, and input-reading keystroke information representing the input reading by a keystroke data string is obtained, and history-data reading keystroke information representing the reading of the history-data storage unit by a keystroke data string is obtained. When the input-reading keystroke information matches a beginning part of the history data reading information, the expression corresponding to the history data reading is selected as a candidate.

Also, in the present invention, a previous input expression is stored in the history-data storage unit. When a next expression is entered, input expression stroke information representing an input expression by a keystroke data string is obtained, and history data expression keystroke information representing the expression in the history-data storage unit by the expression keystroke data string. If the input expression stroke information matches a beginning part of the history data expression stroke information, the expression of the history data is selected as a candidate.

Furthermore, in the present invention, there is provided a device for achieving each processing step constituting the above-described methods of processing. Also, in the present invention, there is provided a program for causing a computer to perform each processing step constituting the above-described methods of processing.

The program which causes a computer to perform each means, function, or element of the present invention can be stored in a suitable recording medium, such as a computer readable removable medium memory, semiconductor memory, hard disk. Also, the present invention is provided by recording in these recording media. Alternatively, the present invention is provided by sending/receiving using various communication networks through a communication interface.

In the present invention, once a reading “sumou” is entered, and an expression “SUMOU” is determined by Chinese character conversion processing, reading keystrokes “33377777111” indicating the operated keys at an entry time of the reading “sumou” with the number of operation times and the expression “SUMOU” are set to history data corresponding with each other, and the history data is stored in the history-data storage unit 13.

Suppose that a reading “sumou” for the expression “SUMOU” is entered from the input unit. For entering a reading “sumou”, “333” is key-operated, thus “su” is entered, and then a “7” key is operated, thus an input stroke “3337” is obtained. Then the input stroke “3337” and reading keystrokes of history data in the history-data storage unit are compared. Thus history data which is forward-matched with the input stroke, that is, which has reading keystrokes starting with “3337” is extracted, and the expression of the history data, for example, the expression “SUMOU” is set to an input prediction candidate. Also, in the present invention, once a reading “sumou” is entered, and an expression “SUMOU” is determined by Chinese character conversion processing, the reading “sumou” and the expression “SUMOU” is set to history data corresponding with each other, and the history data is stored in the history-data storage unit 13.

Suppose that a reading “sumou” is entered for the expression “SUMOU” thereafter. From the reading “su” and the following stroke “7”, an input stroke “337” is obtained, and furthermore a reading of history data in the history-data storage unit is converted to reading keystrokes. Then the converted input stroke “3337” and the converted reading keystroke are compared. Thus the history data which is forward matched, that is, which has reading keystrokes starting with “3337” is extracted, and the expression of the history data, for example, the expression “SUMOU” is set to an input prediction candidate. Also, in the present invention, once a reading “sumou” is entered, and an expression “SUMOU” is determined by Chinese character conversion processing, the reading “sumou” and the expression “SUMOU” is set to history data corresponding with each other, and the history data is stored in the history-data storage unit 13.

Suppose that a reading “sumou” is entered for the expression “SUMOU” thereafter. As an input of a reading “sumou”, “333” is key-operated to enter “su”, and the following “7” key is operated, and thus the input stroke “3337” is obtained. Then the input stroke and the history data reading in the history-data storage unit are compared using the reading “su” and the following stroke “7”. First, history data which starts with the reading “su” is extracted from the history data, and the second reading character of the extracted data is converted to the reading keystrokes. Then history data which has the converted reading keystroke matched with the input stroke “7” is extracted, and the expression “SUMOU” of the history data is set to an input prediction candidate.

In the conventional input prediction processing, from a reading of the four stoke operation “3337”, which is “suma”, the expression “SUMOU” cannot be obtained. In order to enter “sumo” for obtaining candidates including the expression “SUMOU”, eight keystrokes, “33377777”, need to be operated. In the present invention, by only entering a reading “suma” with four keystroke operation, the expression “SUMOU” can be obtained. Thus input operation workload can be reduced greatly.

Also, by the present invention, when input-position shift key information is entered from the input unit, the key information immediately before the input-position shift key is added after the input-position shift key, and a state, in which the next estimated input key is assumed to have been pressed once, is assumed. The input-reading keystroke is set to K1, and is compared with history-data reading keystroke K2 to be selected as a candidate. Therefore, at a point in time when the user pressed an input-position shift key, more adequate candidates can be obtained, and thus input operation workload can be further reduced, and moreover, an adequate input prediction candidates can be presented.

Also, by the present invention, a character string is stored as a reading of history data, and when obtaining a candidate, a reading (character string) is converted to a keystroke data string and is compared with the input keystroke data string to be selected for a candidate. Accordingly, a keystroke conversion suitable for the input processing method at the time of obtaining input prediction candidates can be performed. Thus even if the input processing method is changed in the middle of the way, input prediction candidates can be presented using the stored history data.

Also, by the present invention, only an expression is stored as history data, and when obtaining input prediction candidates, a keystroke data string is obtained from the stored expression, and is compared with the input keystroke data string to be selected as a candidate. Therefore, the present invention can be applied to character input processing in which an input reading (characters) is directly becomes the expression e, and thus it becomes possible to perform input prediction in a wide range of character-input processing.

### BRIEF DESCRIPTION OF THE DRAWINGS

FIG. 1 is a diagram illustrating a configuration example of individual processing means for achieving the present invention;

FIGS. 2A, 2B, and 2C are diagrams illustrating examples of history data and the data structure of a history-data storage unit in a first embodiment;

FIG. 3 is a diagram illustrating an example of a keystroke conversion table in a first embodiment;

FIG. 4 is a diagram illustrating an example of the configuration of an internal-data storage unit in a first embodiment;

FIGS. 5A, 5B, and 5C are diagrams illustrating candidate-obtaining processing in a first embodiment;

FIG. 6 is a diagram illustrating an example of a comparison result of history data in a first embodiment;

FIG. 7 is a diagram illustrating an example of a comparison result of history data in a first embodiment;

FIG. 8 is a flowchart illustrating history-data storage processing in a first embodiment;

FIG. 9 is a flowchart illustrating keystroke conversion processing in a first embodiment;

FIG. 10 is a flowchart illustrating history-data storage processing in a first embodiment;

FIG. 11 is a flowchart illustrating candidate-obtaining processing in a first embodiment;

FIG. 12 is a diagram illustrating an example of history data and the data structure of a history-data storage unit in a second embodiment;

FIG. 13 is a diagram illustrating an example of a comparison result of history data in a second embodiment;

FIG. 14 is a flowchart illustrating candidate-obtaining processing using comparison processing A in a second embodiment;

FIGS. 15A, 15B, 15C, and 15D are diagrams illustrating candidate-obtaining processing by comparison processing B in a second embodiment;

FIG. 16 is a diagram illustrating an example of a comparison result of history data in a second embodiment;

FIG. 17 is a flowchart illustrating candidate-obtaining processing using comparison processing B in a second embodiment;

FIG. 18 is a flowchart illustrating candidate-obtaining processing using comparison processing B in a second embodiment;

FIG. 19 is a diagram illustrating candidate-obtaining processing by comparison processing C in a first embodiment;

FIG. 20 is a diagram illustrating an example of a comparison result of history data in a second embodiment;

FIG. 21 is a flowchart illustrating candidate-obtaining processing using comparison processing C in a second embodiment;

FIG. 22 is a flowchart illustrating candidate-obtaining processing using comparison processing C in a second embodiment;

FIG. 23 is a diagram illustrating an example of a comparison result of history data in a third embodiment;

FIG. 24 is a diagram illustrating an example of a keystroke conversion table in a third embodiment;

FIG. 25 is a diagram illustrating candidate-obtaining processing in a third embodiment;

FIG. 26 is a diagram illustrating candidate-obtaining processing in a third embodiment;

FIG. 27 is a diagram illustrating an example of a comparison result of history data in a third embodiment;

FIG. 28 is a flowchart illustrating candidate-obtaining processing in a third embodiment;

FIG. 29 is a flowchart illustrating candidate-obtaining processing in a third embodiment;

FIG. 30 is a flowchart illustrating keystroke conversion processing in a third embodiment;

FIG. 31 is a diagram illustrating candidate-obtaining processing in a fourth embodiment;

FIG. 32 is a diagram illustrating candidate-obtaining processing in a fourth embodiment;

FIG. 33 is a diagram illustrating candidate-obtaining processing in a fifth embodiment;

FIG. 34 is a diagram illustrating an example of the structure of an internal-data storage unit in a fifth embodiment;

FIG. 35 is a diagram illustrating an example of the structure example of a history-data storage unit in a fifth embodiment;

FIG. 36 is a diagram illustrating candidate-obtaining processing in a fifth embodiment;

FIGS. 37A and 37B are diagrams illustrating an example of a comparison result of history data in a fifth embodiment;

FIG. 38 is a flowchart illustrating candidate-obtaining processing in a fifth embodiment;

FIG. 39 is a flowchart illustrating candidate-obtaining processing in a fifth embodiment;

FIG. 40 is a diagram illustrating candidate-obtaining processing in a sixth embodiment;

FIG. 41 is a diagram illustrating an example of a comparison result of history data in a sixth embodiment;

FIG. 42 is a diagram illustrating candidate-obtaining processing in a sixth embodiment;

FIG. 43 is a diagram illustrating an example of a comparison result of history data in a sixth embodiment; and

FIG. 44 is a diagram illustrating an example of a general terminal device provided with an input unit having a small number of keys, each of which are assigned a plurality of characters.

### DESCRIPTION OF THE PREFERRED EMBODIMENTS

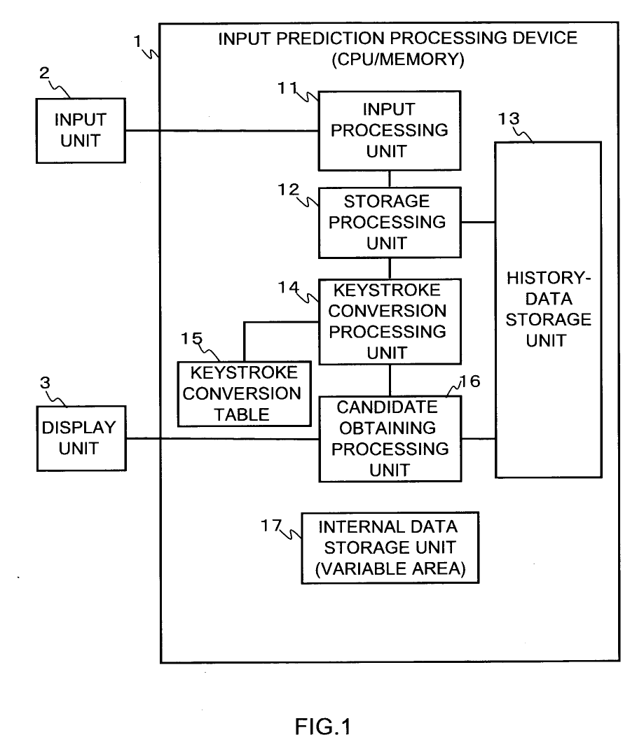

In the following, a description of a first embodiment will be given. FIG. 1 illustrates a configuration example of individual processing means for achieving the first embodiment of the present invention. An input prediction processing device 1 is a device which selects expressions corresponding to an input reading from stored history data and displays them on a display unit 3 as input prediction candidates when a predetermined number of readings are entered into an input unit 2.

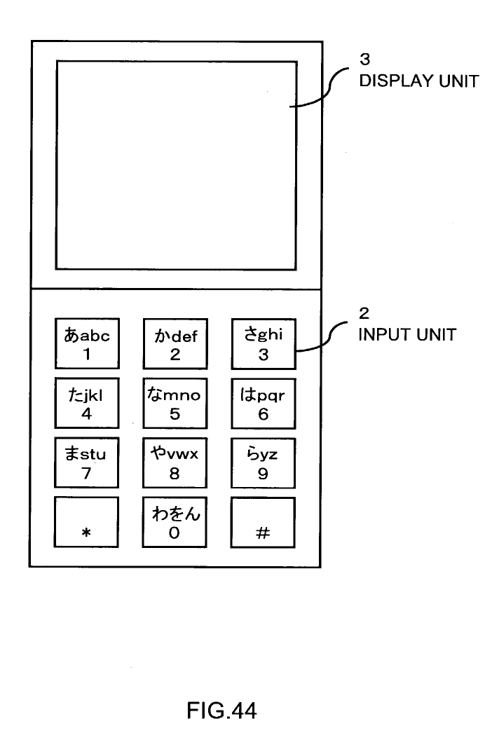

The input unit 2 is a device which has a key pad having a plurality of characters assigned to each of the keys, and which is used for entering the reading (character) set in advance according to the number of times (keystrokes) the key is pressed. The input unit 2 has a numeric-key pad like, for example, that of the input unit 2 of the terminal unit shown in FIG. 44, and a predetermined reading is assigned to each numeric key. The display unit 3 has, for example, an appearance like the display unit 3 included in the terminal unit shown in FIG. 44. The input prediction processing device 1 includes an input processing part 11, a storage processing unit 12, a history-data storage unit 13, a keystroke conversion processing unit 14, a keystroke conversion table 15, a candidate-obtaining processing unit 16, and an internal-data storage unit 17.

The input processing part 11 receives a key-input signal from the input unit 2, and is means for performing input reading processing corresponding to the key. The input processing part 11 passes an expression corresponding to a reading entered or an input reading to the storage processing unit 12.

The storage processing unit 12 is means for storing a reading obtained from the input processing part 11 in an input reading R1 of the internal data storage unit 17 and an expression obtained in an expression E1 as a part of the input processing part 11. The storage processing unit 12 passes the input reading R1 to a keystroke conversion processing unit 14, receives the keystroke conversion processing result, and sets it to an input-reading keystroke K1. A keystroke is information represented by a key information string assigned to the characters constituting a reading. Also, the storage processing unit 12 stores a combination of the input-reading keystroke K1 and the expression E1 in the history-data storage unit 13 as history data (reading r and expression e). Also, the storage processing unit 12 stores a reading r from the history-data storage unit 13 into a history-data reading keystroke K2, and an expression e into the expression E1 upon request by the candidate-obtaining processing unit 16.

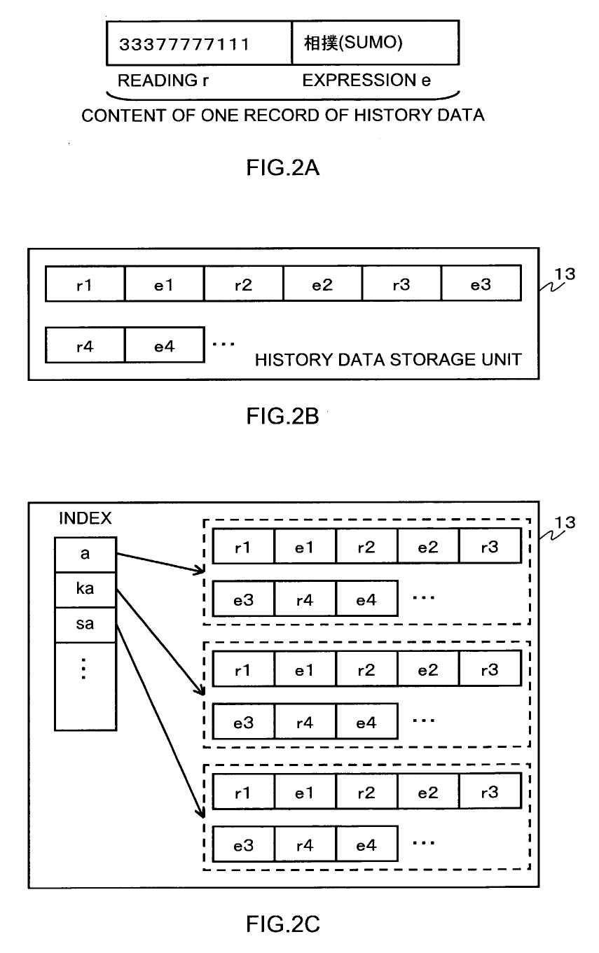

The history-data storage unit 13 is a storage area which stores history data composed of a reading r and an expression e in a predetermined sequence. FIG. 2 illustrates an example of the data structure of the history-data storage unit 13.

In the present embodiment, as shown in FIG. 2A, the history-data storage unit 13 stores a reading r and an expression e as the content of one record of history data, for example, an input-reading keystroke K1 (33377777111) is set as the reading r, and an expression E1 (SUMOU) is set as an expression e. Also, as shown in FIG. 2B, the history-data storage unit 13 stores combined information of the reading r and the expression e produced by conversion processing of a reading r as history data such that the sequence of data is kept as a reading r1 and an expression e1, a reading r2 and an expression e2, a reading r3 and an expression e3, . . . For a storage sequence of a reading r and an expression e, there are cases where a newer reading r and expression e are stored in a previous position, or an older reading r and expression e are stored in a previous position. In this regard, as shown in FIG. 2C, the storage processing unit 12 may store history data hierarchically by providing the history-data storage unit 13 with an index.

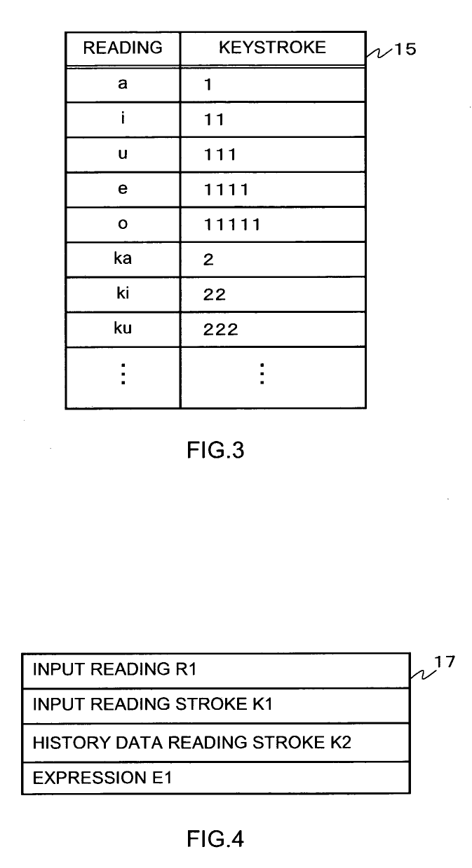

The keystroke conversion processing unit 14 is means for converting a given parameter to a keystroke data string based on the keystroke conversion table 15. The keystroke conversion table 15 is data for defining the relationship between a reading and a keystroke. FIG. 3 illustrates an example of the keystroke conversion table 15. The keystroke conversion table 15 shown in FIG. 3 illustrates a definition example in which “a” is assigned to one stroke of a “1” key of the input unit 2, “i” is assigned to two strokes of the same key, and “o” is assigned to five strokes of the same key.

The candidate-obtaining processing unit 16 is means for adopting an expression e corresponding to a reading (keystroke data string) which matches a candidate reading when a predetermined number of readings to become the target of input prediction processing are entered into the input unit 2. As shown in FIG. 4, the internal-data storage unit 17 is an area for storing internal data (variables) to be used in each processing part. The input reading R1, the input-reading keystroke K1, and the expression E1 are stored therein.

The input reading R1 is a variable to store the reading entered by the input unit 2. The input-reading keystroke K1 is a variable for storing the keystroke of the input reading R1. A history-data reading keystroke K2 is a variable for storing the reading r (keystroke) stored by the history-data storage unit 13. The expression E1 is a variable for storing the expression e stored in the history-data storage unit 13.

In the first embodiment, the input prediction processing device 1 stores, as history data, a combination of the data string (keystroke) in which the input-reading keystroke is converted into a keystroke, and the expression. When a predetermined number of readings is entered, the input prediction processing device 1 compares the keystrokes of the input reading and the keystroke of the history data reading, and if they match by forward matching, the expression corresponding to the reading of the history data is adopted as a candidate.

In the following, a more detailed description will be given. In this regard, the input prediction processing device 1 is assumed to perform input prediction processing when more than one character of reading is entered in the present embodiment and the other embodiments described later. For example, suppose that the “3” key is pressed three times, the “7” key is pressed five times, and the “1” key is pressed three times in the input unit 2, and thus a reading “sumou” is entered, and an expression “SUMOU” is selected. The input processing part 11 passes the reading “sumou” entered in the input unit 2 and the expression “SUMOU” to the storage processing unit 12.

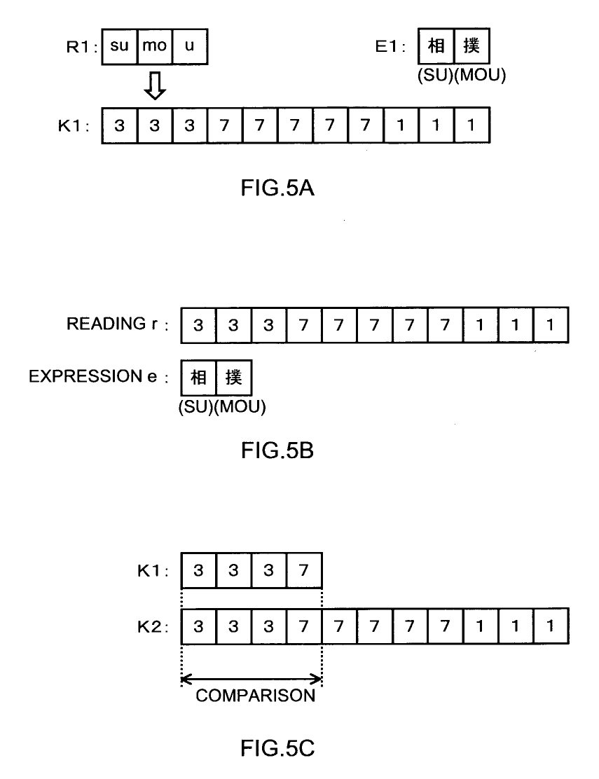

As shown in FIG. 5A, the storage processing unit 12 sets the received reading “sumou” as a reading R1 and the expression “SUMOU” as an expression E1. Then the storage processing unit 12 passes the input reading R1, “sumou”, to the keystroke conversion processing unit 14 as an input parameter. The keystroke conversion processing unit 14 converts the input reading R1, “sumou”, into a keystroke data string “33377777111” using the keystroke conversion table 15, and returns the conversion result to the storage processing unit 12. The storage processing unit 12 receives the return value “33377777111” from the keystroke conversion processing unit 14, and sets as an input-reading keystroke K1. Then, as shown in FIG. 5B, the storage processing unit 12 stores the input-reading keystrokes K1 and the expression E1 into the history-data storage unit 13 as history data (reading r and expression e).

Suppose that, in the input unit 2 thereafter, the “3” key is pressed three times to enter “su”, and the “7” key is then pressed one time to enter “ma”. The storage processing unit 12 receives “suma” from the input processing part 11, and sets as the input reading R1. The candidate-obtaining processing unit 16 passes the input reading R1, “suma”, to the keystroke conversion processing unit 14 as an input parameter, because the input reading R1 is the predetermined number of a syllables or more. The keystroke conversion processing unit 14 converts the input parameter “suma” to keystroke data “3337” based on the keystroke conversion table 15, and returns it to the candidate-obtaining processing unit 16. The candidate-obtaining processing unit 16 sets the returned value “3337” input-reading keystrokes K1. At the same time, the storage processing unit 12 extracts history data (reading r and expression e) stored in the history-data storage unit 13, sets the reading r as a history-data reading keystroke K2, and sets the expression e as expression E1.

Next, as shown in FIG. 5C, the candidate-obtaining processing unit 16 compares the input-reading keystroke K1 “3337” and the history-data reading keystroke K2 “33377777111”. If the input-reading keystroke K1 and the history-data reading keystroke K2 are forward-matched, the expression E1 is adopted as a candidate. The adopted candidate is displayed on the display unit 3.

The candidate-obtaining processing unit 16 performs comparison processing on all the history data stored in the history-data storage unit 13, and selects a predetermined number of candidates. In this regard, the candidate-obtaining processing unit 16 may select candidates based on the time when the history data is stored or the frequency of the candidate selection, etc., or it may determine the output sequence such as display output.

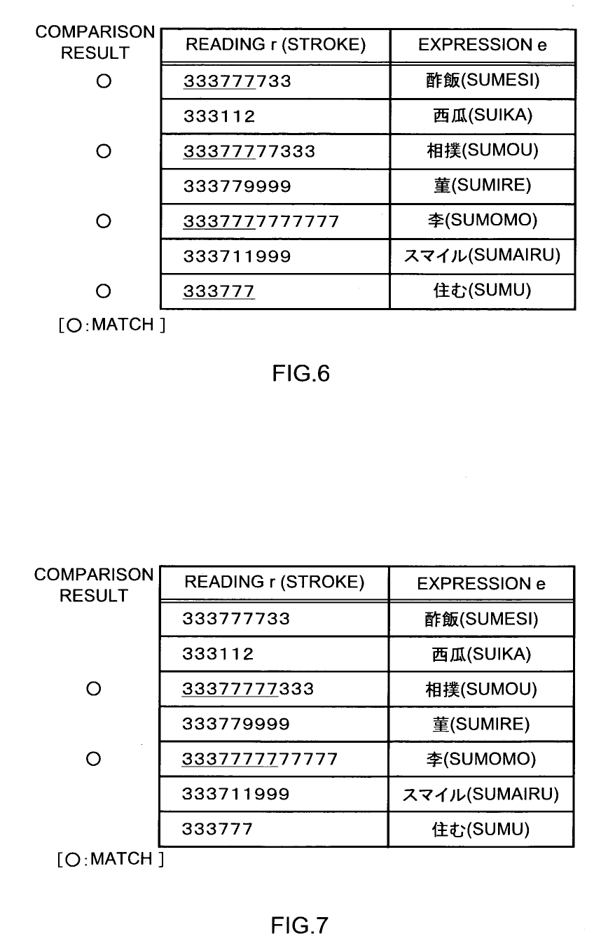

Suppose, as shown in FIG. 6, that combinations of readings r (stroke) and expressions e are stored in the history-data storage unit 13 as history data. In this case, the candidate-obtaining processing unit 16 compares the input-reading keystroke K1 and the history data reading r. The underlined part of the reading r and keystrokes are the parts which are forward-matched. The candidate-obtaining processing unit 16 adopts the expressions e “SUMESI, SUMOU, SUMIRE, SUMOMO, SUMAIRU, SUMU” of the readings r which are forward-matched with the input-reading keystroke K1 “3337”.

Accordingly, the user can obtain candidates, including the expression “SUMOU”, by only a four-stroke operation, “3, 3, 3, 7” in the input unit 2 in order to obtain the expression “SUMOU”. As compared with the conventional input prediction processing, which required an eight-stroke input operation (3, 3, 3, 7, 7, 7, 7, 7), the input operation workload is reduced by the present invention. Suppose that the “7” key is pressed again, and thus “sumi” is entered in the input unit2. By the same processing as described above, the storage processing unit 12 sets the input reading as the input reading R1. The candidate-obtaining processing unit 16 sets the return value “33377”, converted from the input reading R1 to the input-reading keystroke K1, and compares it with history-data reading keystroke K2 which is the reading r in the history-data storage unit 13. The candidate-obtaining processing unit 16 adopts five expressions e “SUMESI, SUMOU, SUMIRE, SUMOMO, SUMU” of the readings r which is forward-matched with the input stroke K1 “333377” from the readings r shown in FIG. 6.

Subsequently, when the same key is pressed in the input unit2, and the input reading is transmitted, the candidate-obtaining processing unit 16 sets the keystroke data value converted from the input reading R1 to the input-reading keystrokes K1, and compares the input-reading keystrokes K1 and the history-data reading keystroke K2 in order to extract a candidate which is forward-matched. For example, when a reading “sumi” has been entered, if the “7” key is pressed again in the input unit 2 to enter “sumu”, from the history data shown in FIG. 6, the expressions e “SUMESI, SUMOU, SUMOMO, SUMU” corresponding to the readings r which are forward-matched with the input-reading keystroke K1 “333777” are selected as candidates.

Furthermore, when the reading “sumu” has been entered, if the “7” key is pressed again in the input unit 2 to enter “sume”, the expressions e “SUMESI, SUMOU, SUMOMO” corresponding to the readings r which are forward-matched with the input-reading keystroke K1 “3337777” are selected as candidates. Also, when the reading “sume” has been entered, if the “7” key is pressed again in the input unit 2 to enter “sumo”, as shown in FIG. 7, out of the history data, the expressions e “SUMOU, SUMOMO” corresponding to the readings r which are forward-matched with the input-reading keystroke K1 “33377777” are selected as candidates.

In this manner, in the input prediction processing device 1, in accordance with the transmission of the input reading by the increased number of keystrokes, the candidates of the input prediction are narrowed down and displayed. Thus, the user can use both of the following operation methods:

(1) A method of selecting a desired expression from a predetermined number of candidates with fewer keystrokes; and

(2) A method of selecting an expression from a narrowed down candidates with many keystrokes

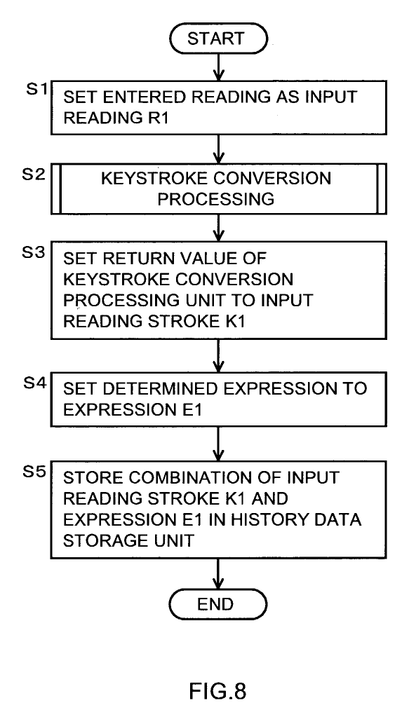

FIG. 8 illustrates a flowchart of history-data storage processing for obtaining input keystrokes using the keystroke conversion processing unit 14. The storage processing unit 12 sets a reading entered by the input unit 2 received from the input processing part 11 as an input reading R1 (step S1). The input reading R1 is passed to the keystroke conversion processing unit 14, and the keystroke conversion processing is performed (step S2). The storage processing unit 12 sets the return value of the keystroke conversion processing as an input-reading keystroke K1 (step S3). Furthermore, the received expression from the input processing part 11 is set as the expression E1 (step S4). A combination of the input-reading keystroke K1 and the expression E1 is stored in the history-data storage unit 13 (step S5).

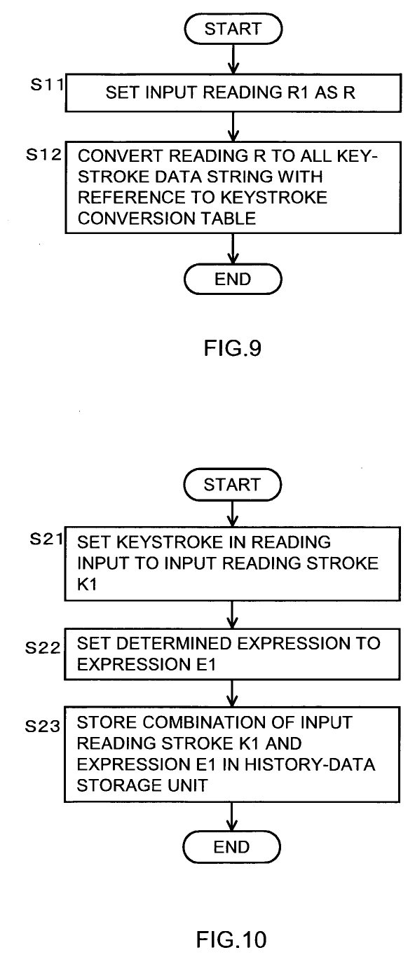

FIG. 9 illustrates a flowchart of the keystroke conversion processing in the step S2 in the flowchart of the processing shown in FIG. 8. The keystroke conversion processing unit 14 sets the input reading R1 received as an input parameter as a reading R (step S11). The reading R is converted to a keystroke data string with reference to the keystroke conversion table, and the processing result (return value) is returned (step S12). Also, the storage processing unit 12 may store an input-reading keystrokes K1 received directly from the input processing part 11 instead of converting the input reading R1 to a keystroke data string (input-reading keystroke K1) by the keystroke conversion processing unit 14 and setting it as a reading r for storing in the history-data storage unit 13.

In this case, the input processing part 11 holds keystrokes entered during reading input by the input unit 2, and passes them to the storage processing unit 12. The storage processing unit 12 sets the received keystrokes as the content of the input-reading keystroke K1, and stores it in the history-data storage unit 13. In this regard, the input processing part 11 may directly store the keystrokes during reading input to the input-reading keystroke K1.

FIG. 10 illustrates a flowchart of history-data storage processing when reading keystrokes are obtained from the input processing part 11. The storage processing unit 12 receives keystrokes during reading input from the input processing part 11, and sets them as the input-reading keystroke K1 (step S21). The storage processing unit 12 receives a determined expression from the input processing part 11, and sets it as the expression E1 (step S22). Furthermore, the storage processing unit 12 stores a combination of the input-reading keystroke K1 and the expression E1 in the history-data storage unit 13 (step S23).

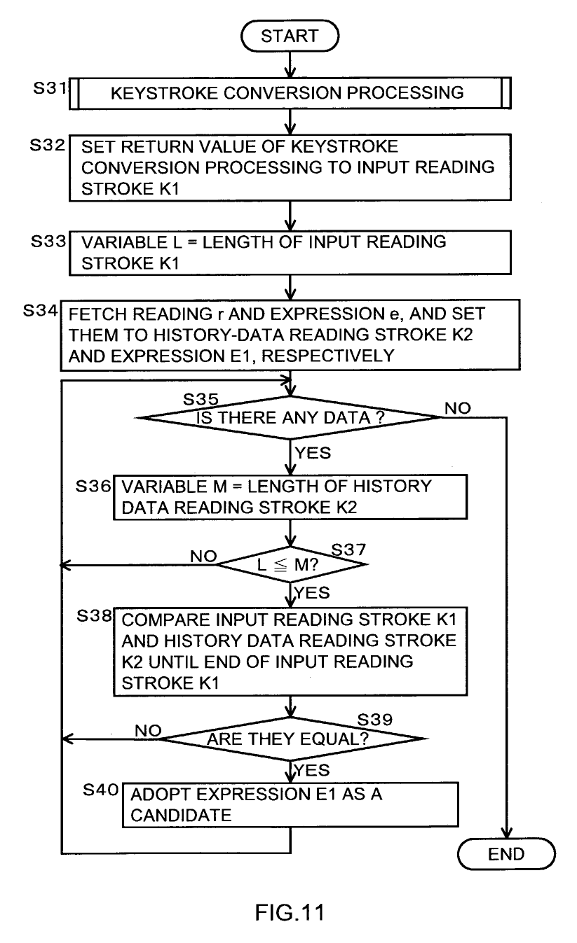

FIG. 11 illustrates a flowchart of candidate-obtaining processing. The candidate-obtaining processing unit 16 starts candidate-obtaining processing when the input reading R1 becomes a predetermined number of syllables or more. The candidate-obtaining processing unit 16 passes the input reading R1 as an input parameter to the keystroke conversion processing unit 14, where the keystroke conversion processing is performed (step S31). The candidate-obtaining processing unit 16 stores the return value of the keystroke conversion processing in the input-reading keystrokes K1 (step S32) and the length of the input-reading keystroke K1 in a variable L (step S33). Furthermore, the storage processing unit 12 fetches history data (reading r and expression e) from the history-data storage unit 13, sets the reading r as history-data reading keystrokes K2, and sets the expression e to the expression E1 (step S34). If the history-data reading keystroke K2 and the expression E1 contain data (step S35), the candidate-obtaining processing unit 16 sets the length of the history-data reading keystroke K2 to a variable M (step S36). If the variable L is equal to or less than the variable M (step S37), a comparison is made between the input-reading keystrokes K1 and the history-data reading keystrokes K2 from the beginning up to the length of the input-reading keystroke K1 (step S38). If both of them are equal (step S39), the expression E1 is adopted as a candidate (step S40). Then while the history-data reading keystroke K2 and the expression E1 of the internal-data storage unit 17 contain no data (step S35), the processing from step S36 to step S40 is repeated, and the processing is terminated when there is no data.

Next, a second embodiment will be described. In the second embodiment, the input prediction processing device 1 stores the entered reading directly as a character string with its expression as history data. If a predetermined number of readings are entered, a comparison is made between the input-reading keystroke and the keystroke data string converted form the history data reading. If they match, the expression corresponding to the reading of the history data is adopted.

In the second embodiment, a configuration example of each processing means for achieving the present invention is similar to the configuration example shown in FIG. 1. In the present embodiment, the internal-data storage unit 17 of the input prediction processing device 1 has an input reading R1, an input-reading keystroke K1, a history data reading R2, a history-data reading keystroke K2, and an expression E1. The history data reading R2 is a variable for holding the history data reading r stored in the history-data storage unit 13.

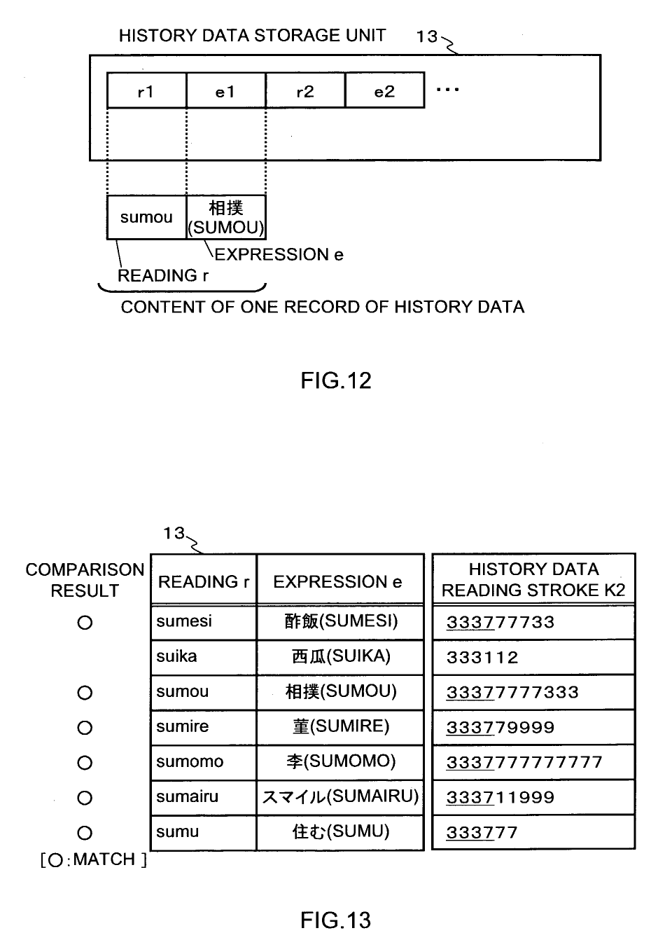

In the history-data storage processing of the present embodiment, the storage processing unit 12 sets the reading received from the input processing part 11 to the input reading R1, and set the content of the input reading R1 directly to the reading r, and stores it in the history-data storage unit 13. For example, the storage processing unit 12 sets the reading “sumou” received form the input processing part 11 to the input reading R1, sets the determined expression “SUMOU” to the expression E1, and as shown in FIG. 12, stores the input reading R1 “sumou” and the expression E1 “SUMOU” in the history-data storage unit 13 as one record (reading r and expression e) of history data.

Here, in order to enter the reading “sumou” in the input unit 2, suppose that a “3” key is pressed three times to enter a reading “su”, and then a “7” key is entered one time to enter a reading “ma”. The storage processing unit 12 obtains history data from the history-data storage unit 13 by the request of the candidate-obtaining processing unit 16, sets the reading r to the history data reading R2, and sets the expression e to the expression E1. The candidate-obtaining processing unit 16 passes the input reading R1 as an input parameter to the keystroke conversion processing unit 14 in the same processing as that of the first embodiment, and sets the return value (keystroke) from the keystroke conversion processing unit 14 to the input-reading keystroke K1. Furthermore, the candidate-obtaining processing unit 16 passes all the content (reading) of history data reading R2 to the keystroke conversion processing unit 14 as an input parameter, and stores the return value of the keystroke conversion processing unit 14 in the history-data reading keystroke K2.

Next, as shown in FIGS. 5A and 5B, the candidate-obtaining processing unit 16 compares the input-reading keystroke K1 and the history-data reading keystroke K2. If they are forward-matched, the expression E1 corresponding to the history data reading R2 is adopted as a candidate. This processing is called “comparison processing A”. For example, suppose that history data (combination of reading r and expression e) as shown in FIG. 13 is stored in the history-data storage unit 13, the keystroke data string of the reading r converted by the keystroke conversion processing unit 14 is set to history-data reading keystrokes K2. In this case, the candidate-obtaining processing unit 16 compares the input-reading keystroke K1 “3337” of the input reading R1 “suma” and the history-data reading keystroke K2. The underlined part of history-data reading keystroke K2 in FIG. 13 indicates the parts which are forward-matched with the input-reading keystroke K1. The candidate-obtaining processing unit 16 selects six expressions e “SUMESI, SUMOU, SUMIRE, SUMOMO, SUMAIRU, SUMU” corresponding to the history-data reading keystroke K2 which is forward-matched with the input-reading keystroke K1 “3337” as candidates.

In the processing of the comparison A of the present embodiment, in the same manner as the first embodiment, the user can obtain candidates including the desired expression “SUMOU” by four-stroke operation, “3337” in the input unit 2. Then when the same key is pressed in the input unit 2 furthermore, and the input reading changes like “sumi→sumu→sume→sumo”, the storage processing unit 12 sets the content entered in the input unit 2 in sequence as the input-reading keystroke R1, and sets the data string keystroke converted from this to the input-reading keystroke K1. Also, the candidate-obtaining processing unit 16 determines a candidate by comparing the input-reading keystroke K1 and history-data reading keystroke K2 in the same manner as the processing described above.

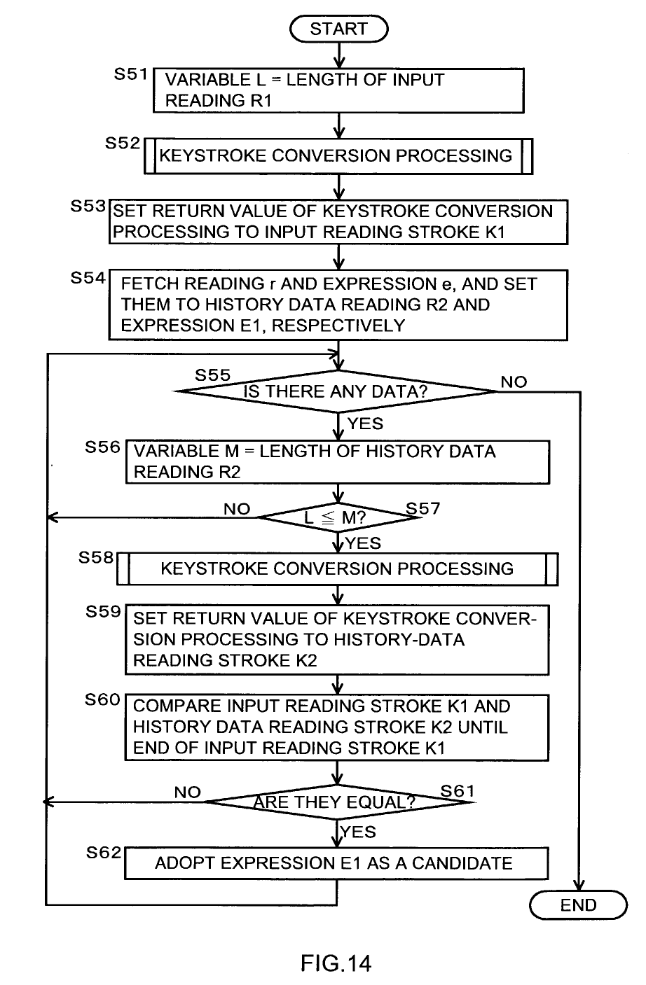

FIG. 14 illustrates a flowchart of the candidate-obtaining processing using the comparison processing A in the present embodiment. The candidate-obtaining processing unit 16 sets the length of input reading R1 to a variable L (step S51). The input reading R1 is set to an input parameter, and is passed to the keystroke conversion processing unit 14, and the keystroke conversion processing is performed (step S52). The return value of the keystroke conversion processing is set to the input-reading keystroke K1 (step S53). The storage processing unit 12 fetches history data (reading r and expression e) from the history-data storage unit 13, sets the reading r to the history data reading R2, and the expression e to the expression E1 (step S54). If there is stored data in the history data reading R2 and the expression E1 (step S55), the candidate-obtaining processing unit 16 sets the length of the history data reading R2 to a variable M (step S56). If the variable L is equal to the variable M or more (step S57), the history data reading R2 is passed to the keystroke conversion processing unit 14 as an input parameter, and the keystroke conversion processing is performed (step S58). The candidate-obtaining processing unit 16 sets the return value of the keystroke conversion processing to the history-data reading keystroke K2 (step S59). Then a comparison is made between the input-reading keystroke K1 and the history-data reading keystroke K2 from the beginning to the length of the input-reading keystroke K1 (step S60). If both of them are equal (step S61), the expression E1 is adopted as a candidate (step S62). Then until the history data reading R2 and the expression E1 have no data (step S55), the processing from step S56 to step S62 is repeated, and the processing is terminated when there is no data.

Moreover another comparison method will be described. This processing is called “comparison processing B”. The candidate-obtaining processing unit 16 keystroke converts the input reading R1 from the beginning by one character in sequence. Furthermore, the characters of the history-data reading keystroke R2 corresponding to the position of the reading (characters) of the input reading R1 to be keystroke converted is keystroke converted, and the return value is set to the input-reading keystroke K1 and the history-data reading keystroke K2. Then a comparison is made between the input-reading keystroke K1 and the history-data reading keystroke K2, the comparison is repeated until immediate before the last character of the input reading R1, and if both of them completely match, a first condition is set to adopt the expression E1 as a candidate. If the first condition is met, the last character of the input reading R1 and the history data reading R2 corresponding to the last character position are keystroke converted, and the result is set to the input-reading keystroke K1 and the history-data reading keystroke K2. If the input-reading keystroke K1 and the history-data reading keystroke K2 are forward-matched, the expression E1 is adopted as a candidate.

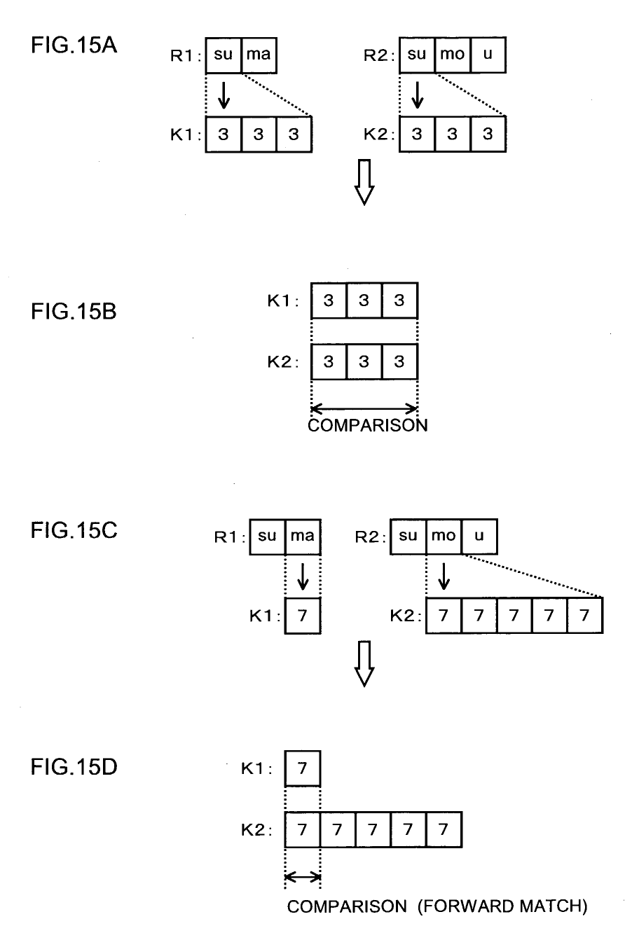

For example, as shown in FIG. 15A, the storage processing unit 12 sets the value “333”, which is keystroke converted from the beginning one character “su” of the input reading R1, to the input-reading keystroke K1, and the value “333”, which is keystroke converted from “su” of the history data reading R2 “sumou” corresponding to the beginning one character “su” of the input reading R1, to the history-data reading keystroke K2.

As shown in FIG. 15B, the candidate-obtaining processing unit 16 compares the input-reading keystroke K1 “333” and the history-data reading keystroke K2 “333”. If both of them completely are matched, as shown in FIG. 15C, the storage processing unit 12 sets the value “7”, which is keystroke converted from the last character “ma” of the input reading R1 “suma”, to the input-reading keystroke K1, and sets the value “77777”, which is keystroke converted from “mo” of the history data reading R2 “sumou” corresponding to the last character “ma” of the input reading R1, to the history-data reading keystroke K2.

The candidate-obtaining processing unit 16 compares the input-reading keystroke K1 and the history-data reading keystroke K2 as far as the length of the input-reading keystroke K1, and if they match completely, that is, if the input-reading keystroke K1 and the history-data reading keystroke K2 are forward-matched, the expression E1 is adopted as a candidate. For example, as shown in FIG. 15D, a comparison is made between the input-reading keystroke K1 “7” and the history-data reading keystroke K2 “7” as far as the length of K1, and if they are matched completely, the expression E1 is adopted as a candidate.

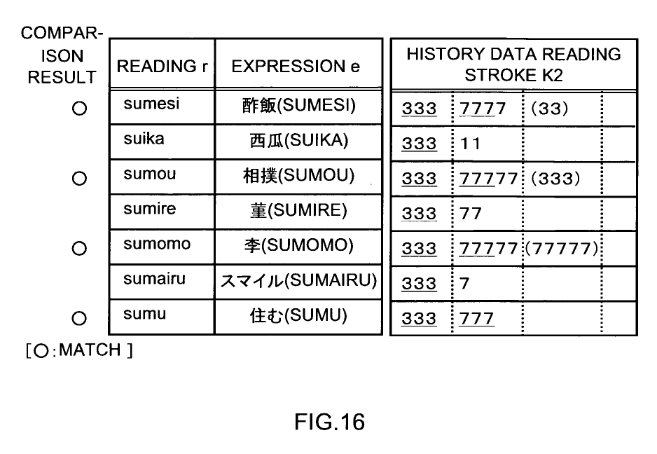

The history data (combination of reading r and expression e) as shown in FIG. 16 is stored in the history-data storage unit 13, and the keystroke data string of the reading r converted by the keystroke conversion processing unit 14 is set to the history-data reading keystroke K2. In this case, the candidate-obtaining processing unit 16 compares the input-reading keystroke K1 “333” of the beginning character “su” if the input reading R1 “sumu”, and the keystroke converted value of the history-data reading keystroke K2 character (reading) corresponding to the position of the beginning character “su”.

Furthermore, a comparison is made between the input-reading keystroke K1 “777” of “mu” of the input reading R1 and the history-data reading keystroke K2, which is the keystroke converted value of the history data reading R2 characters corresponding to the position of “mu” of the input reading R1 “sumu”. At this point in time, all the expression e in history data are completely matched.

Further, the candidate-obtaining processing unit 16 compares the input-reading keystroke K1 “333” of “su” of the input reading R1 “sumu” and the input-reading keystroke K1 “777” of “mu” in the same manner, and four expressions e “SUMESI, SUMOU, SUMOMO, SUMU” corresponding to the history-data reading keystroke K2 which are forward-matched are selected as candidates.

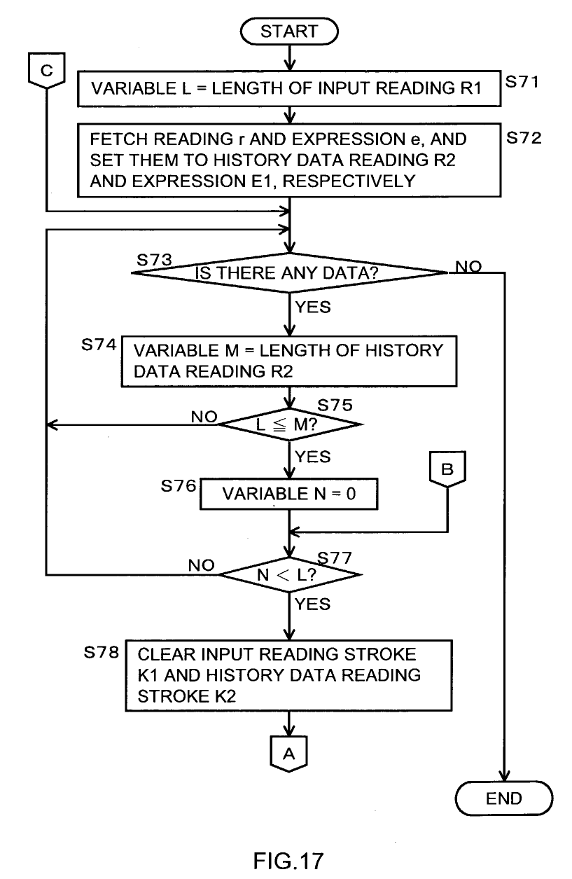

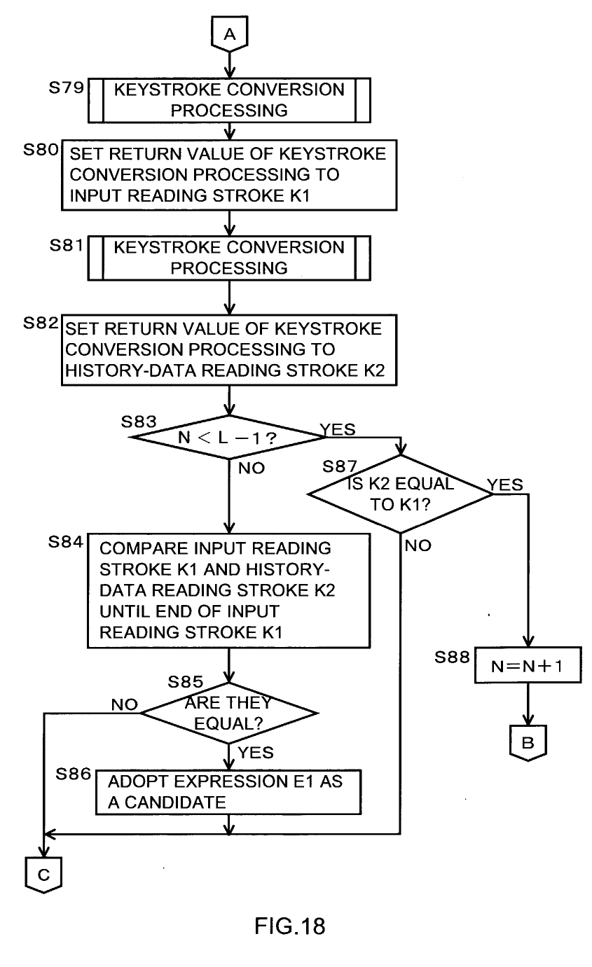

FIGS. 17 and 18 illustrate a flowchart of the candidate-obtaining processing using the compare processing B in the present embodiment. The candidate-obtaining processing unit 16 sets the length of the input reading R1 to a variable L (step S71). The storage processing unit 12 fetches history data (reading r and expression e) from the history-data storage unit 13, sets the reading r to the history data reading R2, and the expression e to the expression E1 (step S72). If there is stored data in the history data reading R2 and the expression E1 (step S73), the candidate-obtaining processing unit 16 sets the length of the history data reading R2 to a variable M (step S74). If the variable L is equal to the variable M (step S75), the variable N is set to 0 (step S76). Then while the variable N is smaller than the variable L (step S77), the input-reading keystroke K1 and the history-data reading keystroke K2 are cleared (step S78). The Nth character of the input reading R1 is passed to the keystroke conversion processing unit 17 as an input parameter, and the keystroke conversion processing is performed (step S79). The return value of the keystroke conversion processing is set to the input-reading keystroke K1 (step S80). Further, the Nth character of the history data reading R2 is passed to the keystroke conversion processing unit 17 as an input parameter, and the keystroke conversion processing is performed (step S81). The return value is set to the history-data reading keystroke K2 (step S82). Then the processing from step S87 to S88 is repeated until the variable N is smaller than variable L−1 (length of input reading R1−1)(step 83).

Also, in the processing of step S83, if the variable N becomes equal to the variable L−1 or more, the candidate-obtaining processing unit 16 compares the input-reading keystroke K1 and the history-data reading keystroke K2 as far as the length of the input-reading keystroke K1 (step S84), and if both of them are equal (step S85), the expression E1 is adopted as a candidate (step S86). In step S83, if the variable N is smaller than the variable L−1, and the history-data reading keystroke K2 and the input-reading keystroke K1 are equal (step S87), 1 is added to the variable N (step S88), and the processing is returned to step S77. Then the processing from step S74 to step S86 is repeated until there is no data in the history data reading R2 and the expression E1 of the internal-data storage unit 17 (step S73), and if there is no data, the processing is terminated.

Furthermore, another comparison method will be described. This processing is called “comparison processing C”. The candidate-obtaining processing unit 16 compares the input reading R1 and the history data reading R2 in the range from the beginning to the reading (characters) of the length of the input reading R1−1. If the reading is completely matched, the last character of the input reading R1 and the history data reading R2 character corresponding to the character position are keystroke converted individually. The converted keystroke data strings are compared, and a candidate which is forward-matched is adopted.

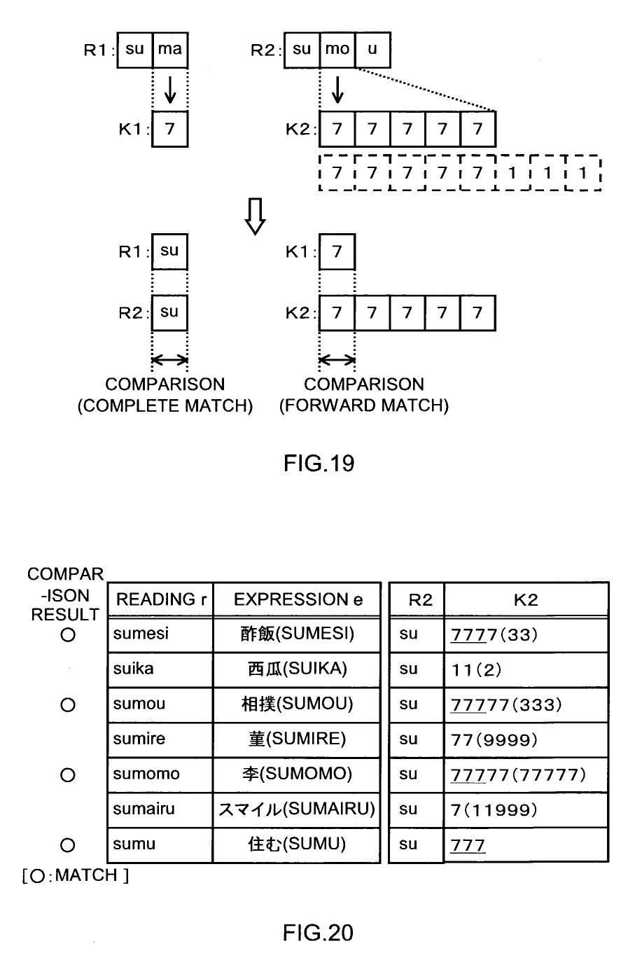

As shown in FIG. 19, the candidate-obtaining processing unit 16 compares as far as one character before the last “su” of the input reading R1 “suma” and as far as the character “su” of the same position of the character taken as in the input reading R1 from the history data reading R2 “sumou”, and determines whether they are completely matched. Then if they are completely matched, the storage processing unit 12 sets the keystroke converted value “7” from the last character “ma” of the input reading R1 “suma” to the input-reading keystroke K1, and the keystroke converted value “77777” from the character “mo” or the character following “mo” corresponding to the “ma” position of the input reading R1 of the history data reading R2 “sumou” to the history-data reading keystroke K2. Thereafter, the candidate-obtaining processing unit 16 compares the input-reading keystroke K1 “7” and the history-data reading keystroke K2 of the same length as the input-reading keystroke K1 “77777”, and if they are forward-matched, the expression E1 is adopted as a candidate.

Suppose that history data (combination of reading r and expression e) as shown in FIG. 20 is stored in the history-data storage unit 13, and a reading “sumu” is entered from the input unit 2. In this case, it is determined whether or not the beginning character “su” of the input reading R1 and the character (reading) of the history data reading R2 corresponding to this beginning character “su” are matched. For the beginning character “su” of the input reading R1, all the reading r are matched. Further, the candidate-obtaining processing unit 16 compares input-reading keystroke K1 “777” of “mu” of the input reading R1 “sumu” and the history-data reading keystroke K2 corresponding to the character “mu”, and selects the expression e's, “SUMESI, SUMOU, SUMOMO, SUMU” corresponding to the history-data reading keystroke K2 which are forward matched, as four candidates.

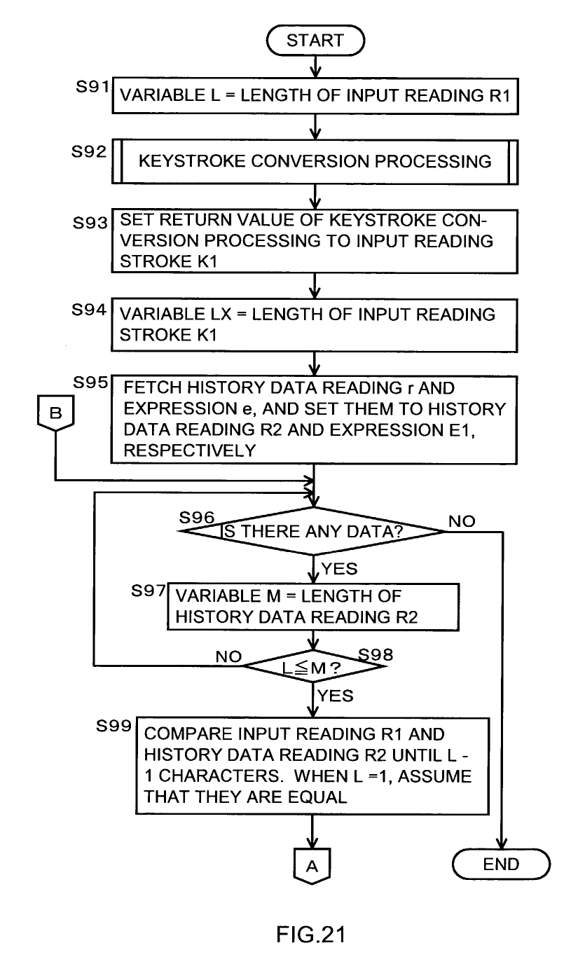

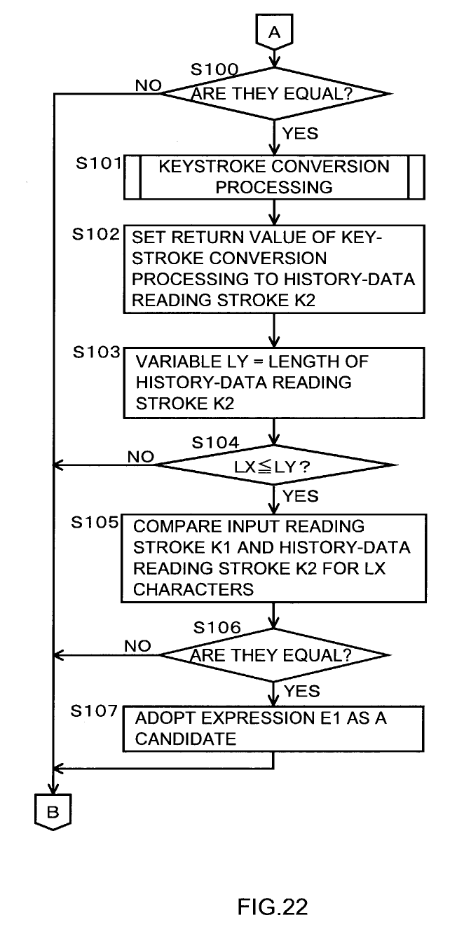

FIGS. 21 and 22 illustrate a flowchart of the candidate-obtaining processing using the comparison processing C in the present embodiment. The candidate-obtaining processing unit 16 sets the length of the input reading R1 to a variable L (step S91). The last character of the input reading R1 is passed to the keystroke conversion processing unit 17 as an input parameter, and the keystroke conversion processing is performed. (step S92). The return value of the keystroke conversion processing is set to the input-reading keystroke K1 (step S93). The length of the input-reading keystroke K1 is set to a variable LX (step S94). Then the storage processing unit 12 fetches history data (reading r and expression e) from the history-data storage unit 13, sets the reading r to the history data reading R2, and the expression e to the expression E1 (step S95). If there is data in the history data reading R2 and the expression E1 (step S96), the candidate-obtaining processing unit 16 sets the length of the history data reading R2 to a variable M (step S97). If the variable L is equal to or less than the variable M (step S98), a comparison is made between the input reading R1 and the history data reading R2 as far as L−1 characters.

In this regard, if L=1, it is regarded as equal (step S99). If both of them are equal (step S100), L−1 th one character from the beginning of the history data reading R2 (or all characters following the L−1 th) is passed to the keystroke conversion processing unit 17, and the keystroke conversion processing is performed (step S101). The return value of the keystroke conversion processing is set to the input-reading keystroke K2 (step S102). Then the length of the input-reading keystroke K2 is set to a variable LY (step S103). If the variable LX is equal to the variable LY or less (step S104), a comparison is made between the input-reading keystroke K1 and the history-data reading keystroke K2 from the beginning to LX characters (step S105). If both of them are equal (step S106), the expression E1 is adopted as a candidate (step S107). Until the history data reading K1 and the expression E1 have no data (step S96), the processing from step S97 to step S107 is repeated, and the processing is terminated when there is no data.

In the following, a third embodiment will be described. Consider the case where different characters belonging to a group of characters assigned to the same input key continue. For example, suppose that, as history data (reading r and expression e), a reading r “ao” and expression e “AO”, and a reading r “ie” and expression e “IE” are stored in the history-data storage unit 13. A reading r of the history data is stored as an input-reading keystroke data string, and thus the input reading “ao” is stored as the reading r “111111”, and the reading “ie” is stored as the reading r “111111”. In this case, when “a” is entered in the input unit 2 in order to obtain the expression “AOKI”, the candidate-obtaining processing unit 16 adopts the expression “IE”, which is corresponding to the reading “111111 (ie)” forward-matched with the input-reading keystroke, and thus an inappropriate candidate for the user is displayed.

In the case where different characters belonging to a group of characters assigned to the same input key continue, the reading (character) is usually assigned in a toggle state with respect to the number of key operations. Accordingly, in order to select a reading, an input operation is performed such that, first, one reading is entered, and then a specific key is pressed to shift the reading input position, and then the same input key is pressed. For example, in order to enter a reading “ao” in the input unit 2, after pressing a “1” key once to enter “a”, a reading input position shift key (in the following, called “input position shift key”), for example, such as an arrow key (denoted by “→”) is pressed, and a “1” key is pressed five times to enter a reading “o”. In this case, the input operation of the reading “ao”, that is, the keystroke becomes “1→11111”.

In the present embodiment, more appropriate input prediction candidate can be presented using the input position shift key information. In the present embodiment, an input prediction processing device 1 is the same means as the configuration example of the input prediction processing device 1 described in the first embodiment, and determines candidates of the input prediction by the similar processing as the processing described in the first embodiment.

An input processing part 11 passes the input position shift key information entered in the input unit 2 to the storage processing unit 12. The storage processing unit 12 sets a combination of the input reading and the input position shift key as an input reading R1, and stores it in the history-data storage unit 13 as the history data reading r. For example, when the storage processing unit 12 receives an input “a, →, o, ki” from the input unit 2, the storage processing unit 12 sets a reading “a→oki” including the input position shift key information entered to the input reading R1, and passes the input reading R1 to the keystroke conversion processing unit 14 as an input parameter.

The keystroke conversion processing unit 14 converts the reading part of the input reading R1 to keystrokes using the keystroke conversion table 15 shown in FIG. 3, and the input position shift key information is added directly. The return value “1→1111122” is set to the input keystroke K1, the input keystroke K1 is set to the reading r, and is stored in the history-data storage unit 13 together with the expression e “AOKI”. When a reading “a→o” is entered in the input unit 2 thereafter, the storage processing unit 12 sets the input reading “a→o” to the input reading R1, sets the return value “1→11111” from the keystroke conversion processing to input-reading keystroke K1, and further sets the reading r of the history-data storage unit 13 to the history-data reading keystroke K2. The candidate-obtaining processing unit 16 compares the input-reading keystroke K1 and the history-data reading keystroke K2. If the input-reading keystroke K1 and the history-data reading keystroke K2 are forward-matched, the expression E1 is adopted as a candidate.

In the present embodiment, by using the input position shift key information as the history data, when a reading “ao” is entered, an inappropriate candidate, such as the expression e “IE” will not be extracted. Generally, when the input position shift key is pressed in the input unit 2, there is a high possibility that the same input key as the immediate before the input position shift key is pressed. Therefore, when the last character of the input reading received as an input parameter is the input position shift key, the keystroke conversion processing unit 14 converts the content of the input reading R1 to keystrokes, adds the reading keystroke data immediate before the input position shift key after the input position shift key information, and returns the data string to the candidate-obtaining processing unit 16.

Suppose a reading “a, →” is entered in the input unit 2. The candidate-obtaining processing unit 16 passes the input reading R1 “a→” to the keystroke conversion processing unit 14 as an input parameter. The keystroke conversion processing unit 14 keystroke converts the input reading R1 “a→” based on the keystroke conversion table 15, sets the input-reading keystroke K1 to “1”, adds “→”, adds “1” of the immediate before “→”, and returns the processing result “1→1” to the candidate-obtaining processing unit 16. Thereafter, the candidate-obtaining processing unit 16 compares the input-reading keystroke K1 “1→1” and the history data reading R2, and the expression E1 of the forward-matched expression e is adopted as a candidate.

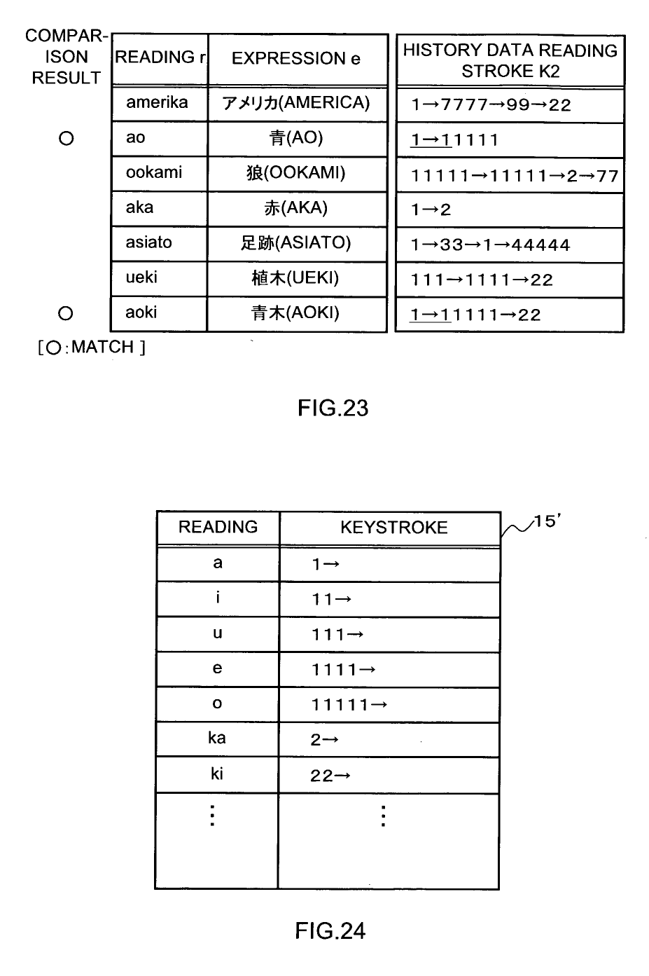

Suppose a combination of a reading r and an expression e shown in FIG. 23 as history data is stored in the history-data storage unit 13. The candidate-obtaining processing unit 16 compares the input-reading keystroke K1 “1→1” keystroke converted from the input reading R1, and the history-data reading keystroke K2, which is the reading r content. The underlined parts of the history-data reading keystroke K2 in FIG. 23 are the parts which are forward-matched. The expression e “AO, AOKI” corresponding to the reading r “ao, aoki” are extracted as candidates.

In this regard, when an input key is not added immediate after the input position shift key, the input-reading keystroke K1 to be compared becomes “1→”. Accordingly, the history data reading r “amerika, ao, aka, asiato, aoki” are matched, thus the expression e “AMERICA, AO, AKA, ASIATO, AOKI” are selected as candidates, and thus inappropriate candidates, such as “AMERICA, AKA, ASIATO” are included. In this manner, in the present embodiment, only at the point in time when the user pressed the input position shift key, it is assumed that next estimated input key has been pressed once, and thus an input prediction candidate can be obtained.

Also, in the present embodiment, an input prediction candidate is determined by the almost same processing as the processing described in the second embodiment. In the history-data storage processing, when an input position shift key is included in the reading entered by the input unit 2, the storage processing unit 12 deletes the input position shift key from the input reading to produce input reading R1, sets the input reading R1 to reading r, and stores it in the history-data storage unit 13 together with the expression e. Thereafter the storage processing unit 12 sets the input reading to the input reading R1, converts the input reading R1 to the keystroke data string by the keystroke conversion processing 14 to produce the input-reading keystroke K1. The storage processing unit 12 sets a reading r of the history-data storage unit 13 to the history data reading R2 by the request of the candidate-obtaining processing unit 16, and passes the history data reading R2 to the keystroke conversion processing 14 as an input parameter.

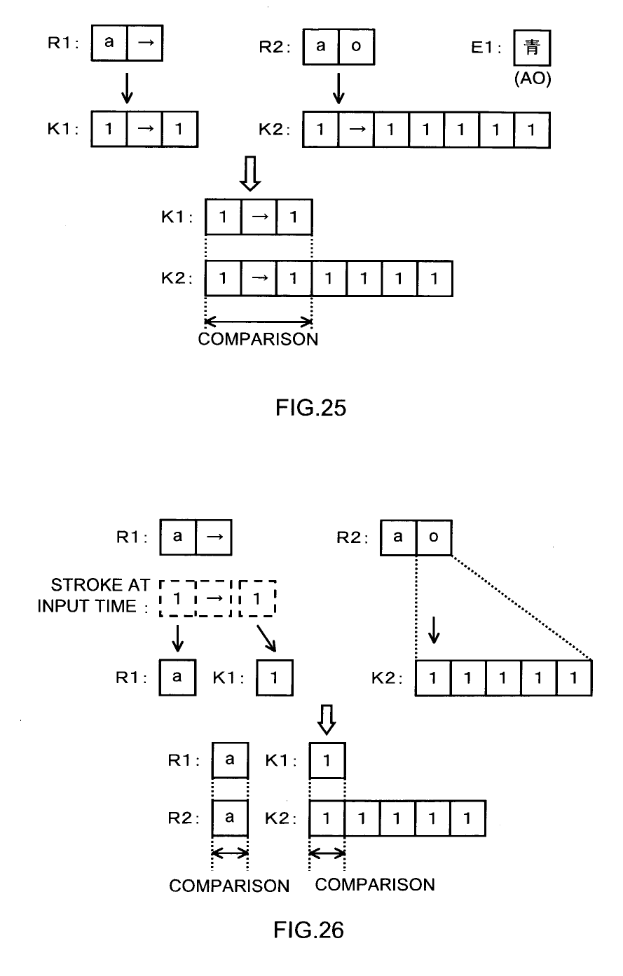

The keystroke conversion processing 14 converts the history data reading R2 to a keystroke data string including the input position shift key based on the keystroke conversion table 15′ shown in FIG. 24, and deletes the last input position shift key (→) to produce the history-data reading keystroke K2. As shown in FIG. 25, the storage processing unit 12 keystroke converts the input reading R1 “a→”, adds the reading immediately before to the result, and sets the value “1→1” in the input-reading keystroke K1. Also, the history data reading R2 “ao” is keystroke converted, and the last input position shift key is deleted to produce the value “1→11111” as the history-data reading keystroke K2. Thereafter the candidate-obtaining processing unit 16 compares the input-reading keystroke K1 “1→1” and the history-data reading keystroke K2, and if they are forward-matched, the expression E1 “ao” is adopted as a candidate.

Also, as shown in FIG. 26, the candidate-obtaining processing unit 16 compares the character “a”, which is before the last character of the input reading R1 “a→”, and the character “a”, which is the character having the same position of the character taken for the input reading R1 from the history data reading R2 “ao”, and determines if they are completely matched. Then if they are matched completely, the storage processing unit 12 sets the value “1”, which is the immediate reading keystroke value of the last “→” of the input reading R1 “a→”, to the input-reading keystroke K1, and the value “11111”, which is keystroke converted from the character “o” corresponding to the position of the input value R1 “→” of the history data reading R2 “ao”, to the history-data reading keystroke K2. Thereafter the candidate-obtaining processing unit 16 compares the input-reading keystroke K1 “1” and the history-data reading keystroke K2, and if they are forward-matched, the expression E1 “AO” is adopted as a candidate.

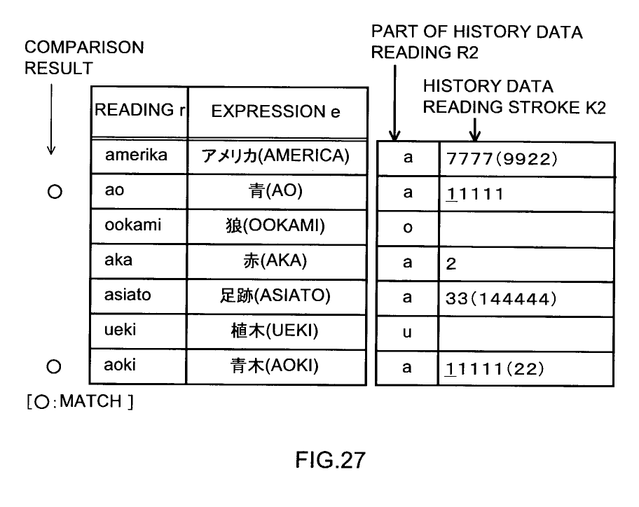

For example, when history data (combination of reading r and expression e) as shown in FIG. 27 is stored in the history-data storage unit 13, and a reading “a→” is entered in the input unit 2, a comparison is made between the beginning character “a” of the input reading R1 and the character (reading) of the history data reading R2 corresponding to the beginning character “a” in order to determine if they are matched. Furthermore, candidate-obtaining processing unit 16 compares the input-reading keystroke K1 “1”, which is obtained by the above-described processing from “→” of the input reading R1 “a→”, and the history-data reading keystroke K2, which is keystroke converted from the history data reading R2. If they are forward-matched, two corresponding expression e “AO, AOKI” are set to candidates.

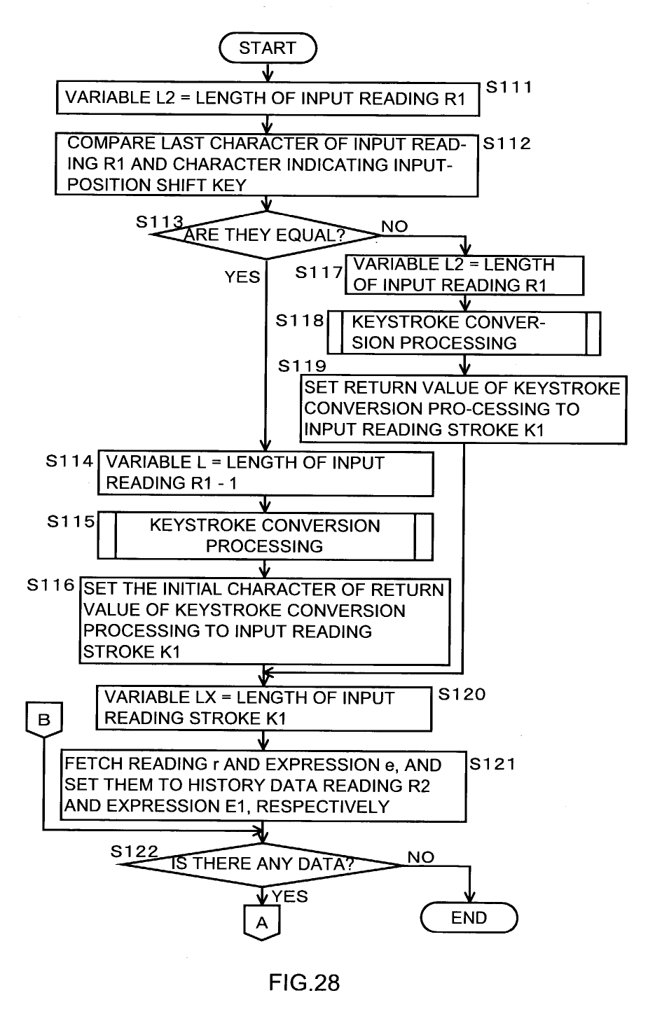

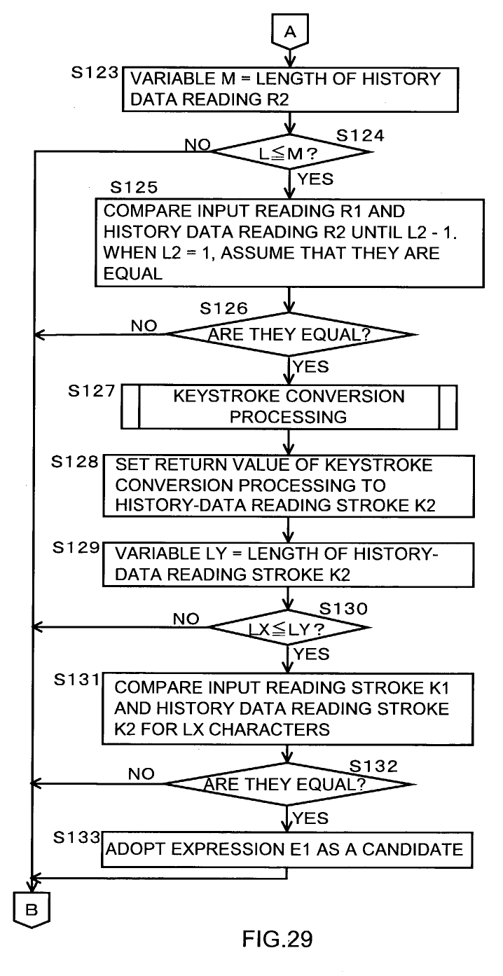

FIGS. 28 and 29 illustrates the flowchart of the candidate-obtaining processing in the third embodiment. The candidate-obtaining processing unit 16 sets the length of the input reading R1 to a variable L2 (step S111). A comparison is made between the last character of the input reading R1 and the character “→” indicating input-position shift (step S112). If the last character of the input reading R1 and the character “→” indicating input-position shift are equal (step S113), the length of the input reading R1−1 is set to the variable L (step S114). The L−1 th character of the input reading R1 is passed to the keystroke conversion processing unit 14 as an input parameter, and the keystroke conversion processing is performed. (step S115). The beginning one character of the return value of the keystroke conversion processing is set to the input-reading keystroke K1 (step S116). If the last character of the input reading R1 and the character (→) indicating the input-position shift are not equal (step S113), the length of the input reading R1 is set to the variable L (step S117). The last character of the input reading R1 is passed to the keystroke conversion processing unit 14 as an input parameter, and the keystroke conversion processing is performed (step S118). The return value of the keystroke conversion processing is stored in the input-reading keystroke K1 (step S119).

The length of the input-reading keystroke K1 is set to a variable LX (step S120). Then the storage processing unit 12 fetches reading r and expression e, sets the reading r to the history data reading R2, and the expression e to the expression E1 (step S121). If there is data in the history data reading R2 and the expression E1 (step S122), the length of the history data reading R2 is set to a variable M (step S123). Then if the variable L is equal to or less than the variable M (step S124), a comparison is made between the input reading R1 and the history data reading R2 as far as L2−1 characters. If L2=1, the input reading R1 and the history data reading R2 are regarded as equal (step S125). If both of them are equal (step S126), L2−1 th one character of the history data reading R2 or all characters following this are passed to the keystroke conversion processing unit 14 as an input parameter, and the keystroke conversion processing is performed (step S127). The return value of the keystroke conversion processing is set to the input-reading keystroke K2 (step S128). The length of the input-reading keystroke K2 is set to a variable LY (step S129). If the variable LY is equal to the variable LX or more (step S130), a comparison is made between the input-reading keystroke K1 and the history-data reading keystroke K2 until LX the characters (step S131). If both of them are equal (step S132), the expression E1 is adopted as a candidate (step S133). Thereafter until the history data reading R2 has data (step S121), the processing from step S122 to step S133 is repeated.

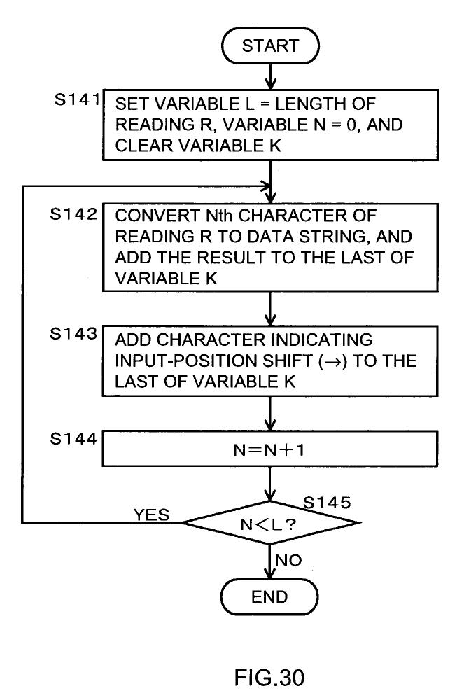

FIG. 30 illustrates a flowchart of the keystroke conversion processing which appears in steps S115 and S118 in FIG. 28, and in step S127 in FIG. 29. The keystroke conversion processing unit 14 sets the received input parameter to reading R, sets the length of the reading R to a variable L, sets the variable N to 0, and clears the variable K (step S141). The N th character of the reading R is converted to keystroke data string, and the result is added to the last of the variable K (step S142). Furthermore, the input-position shift information (→), such as “→” is added to the last of the variable K (step S143). One is added to the variable N, and while the variable N is smaller than the variable L, the processing from step S142 to step S144 is repeated (step S145).

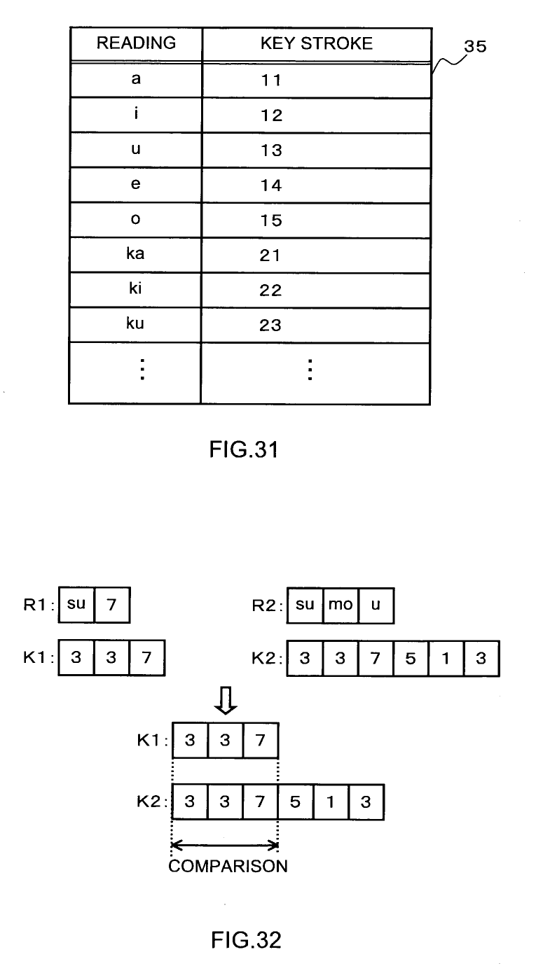

In the following, a fourth embodiment will be described. In the descriptions from the first to the third embodiments described above, the descriptions have been given of the case where the input processing part 11 distinguishes input characters by the number of strokes of input keys into the input unit 2. However, the present invention can be applied to the case which is so-called a “pager method” input, that is, the case where input characters are distinguished by a combination of more than one input key. In this case, keystroke conversion is performed using, for example, a keystroke conversion table as shown in FIG. 31. For example, the keystroke data string of a reading “sumou” becomes “337513”.

In the present embodiment, an input prediction processing device 1 is the same means as the configuration example of the input prediction processing device 1 described in the first and the second embodiments, and extracts candidates of the input prediction by performing various processing described in the first and the second embodiments. In the candidate-obtaining processing, suppose that, as shown in FIG. 32, a reading “su” is entered in the input unit 2, and subsequently, a “7” key is pressed for a reading “mo”. In this case, the storage processing unit 12 receives “su, 7”, and set the input reading R1 to “su7”. Also, the storage processing unit 12 sets the reading r “sumou” from the history-data storage unit 13 to the history data reading R2, and the expression e “SUMOU” to the expression E1. Thereafter the candidate-obtaining processing unit 16 compares the input-reading keystroke K1 “337”, which is keystroke converted from the input reading R1, and the history-data reading keystroke K2 “337513”. If they are forward-matched, the expression E1 “SUMOU” is adopted as a candidate.

In the following, a fifth embodiment will be described. In the descriptions from the first to the fourth embodiments described above, the descriptions have been given of the case where the history data stored in the history-data storage unit 13 is a combination of a reading and the expression.

In the present embodiment, a description will be given of the case where input prediction processing is performed such that characters indicating a reading directly becomes an expression, for example, when inputting a plurality of alphanumeric characters assigned to each numeric key of the input unit 2. In the present embodiment, an input prediction processing device 1 is the same means as the configuration example of the input prediction processing device 1 described from the first to the third embodiments, and extracts candidates of the input prediction by performing various processing described in the first and the second embodiments.

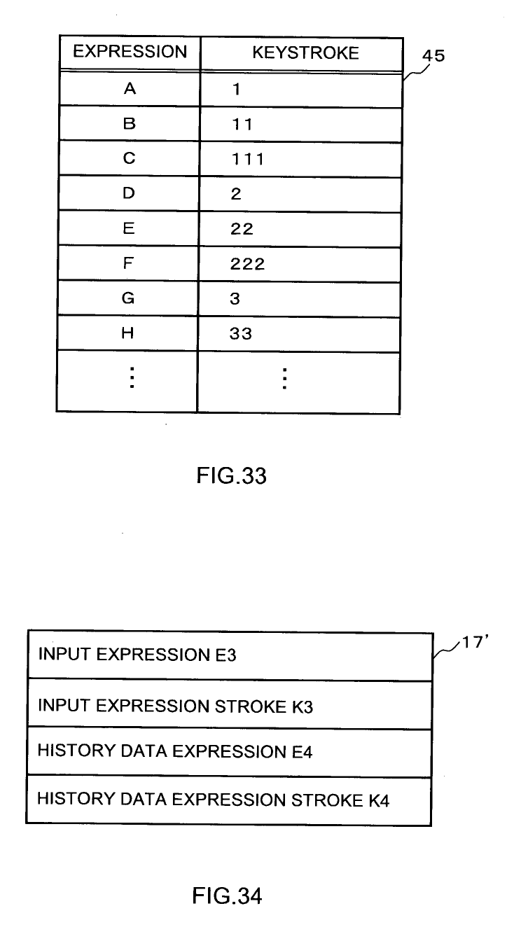

Suppose that the assignment of the alphabet characters to the numeric keys of the input unit 2 is, for example, the assignment shown by the keystroke conversion table 45 shown in FIG. 33. When “SIZE” is entered in the input unit 2, the keystroke data string becomes “73339922”. As shown in FIG. 34, the internal storage part 17′ has four variables, that are, an input expression E3, an input expression stroke K3, a history data expression E4, and a history data expression stroke K4. The input expression E3 is a variable to store the expression entered in the input unit 2. The input expression stroke K3 is a variable to store the keystroke converted data string of the input expression E3. The history data expression E4 is a variable to store the expression e which is fetched from the history-data storage unit 13. The history data expression stroke K4 is a variable to store the keystroke conversion processed data string of the history data example E4.

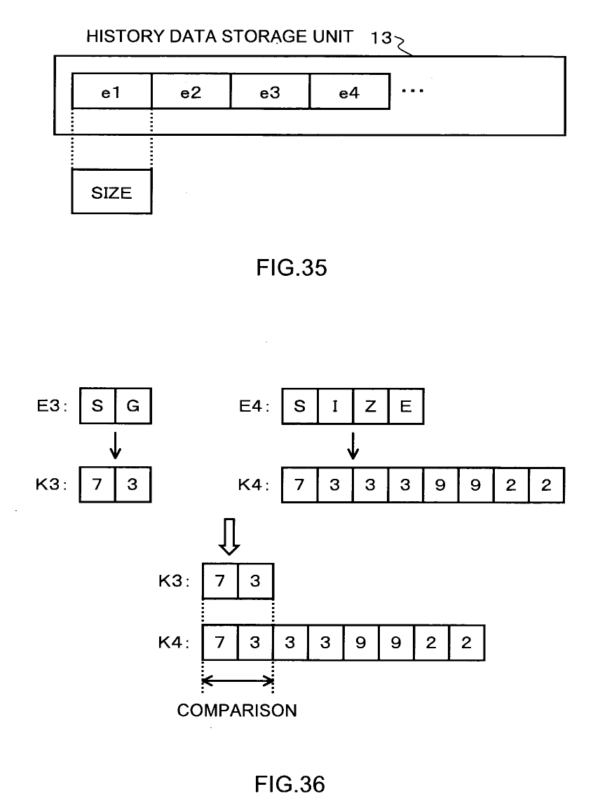

When a character is entered in the input unit 2, the storage processing unit 12 sets the input character from the input processing part 11 to input expression E3. Then as shown in FIG. 35, the content of the input expression E3 is stored in the history-data storage unit 13 as history data (expression e). Thereafter when a predetermined number of characters are input in the input unit 2, the storage processing unit 12 obtains an expression e from the history-data storage unit 13 by the request of the candidate-obtaining processing unit 16, sets it as the history data expression E4. Also, the candidate-obtaining processing unit 16 passes the input expression E3, which is the entered character, as an input parameter to the keystroke conversion processing unit 14, and sets the return value to the input expression stroke K3. In the same manner, the return value by the keystroke conversion processing having the history data expression E4 as an input parameter is set to history data expression stroke K4. Then the candidate-obtaining processing unit 16 compares the input expression stroke K3 and the history data expression stroke K4, and if they are matched, the history data expression E4 is adopted as a candidate.

As shown in FIG. 36, suppose that the expression e “SIZE” is stored in the history-data storage unit 13, and in order to obtain the expression “SIZE” in the input unit 2, “S” is obtained by a “7” key, and then a “3” key is pressed. The storage processing unit 12 sets the value “73” produced by the keystroke processing of the input expression E3 “S, 3”. The candidate-obtaining processing unit 16 compares the history data expression stroke K4 “73339922”, which is the keystroke conversion processed data string from the history data expression E4 “SIZE” obtained by the storage processing unit 12, and the input expression stroke K4 “73”, and if they are forward-matched, the history data expression E4 “SIZE” is adopted as a candidate.

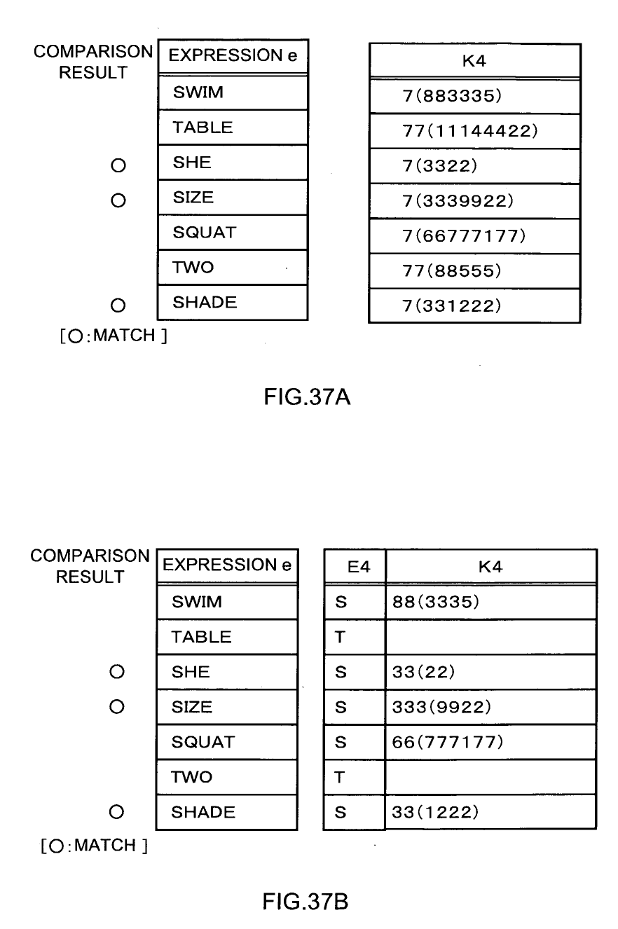

FIGS. 37A and 37B show the comparison result example. FIG. 37A is a result example when comparison processing is performed whether or not input expression and the expression stored in the history-data storage unit 13 are converted to keystroke data strings and matched with each other. Also, FIG. 37B is a result example when the input expression and the expression stored in the history-data storage unit 13 are compared with leaving a part of the expression as they are (characters), and converting a part into keystroke data string. In FIGS. 37A and 37B, matched expression e is indicated by attaching a circle mark. The candidate-obtaining processing unit 16 adopts the forward-matched expressions e “SHE, SIZE, SHADE” as candidates.

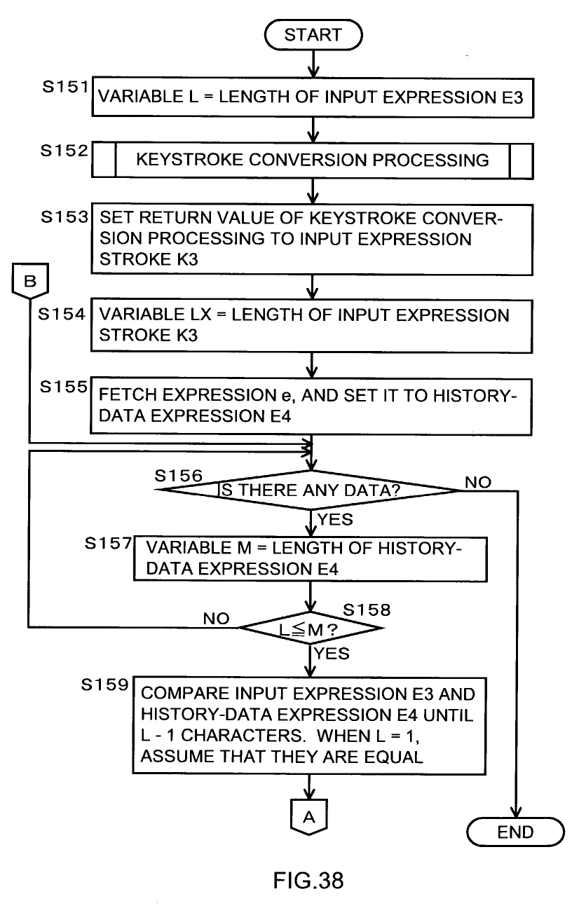

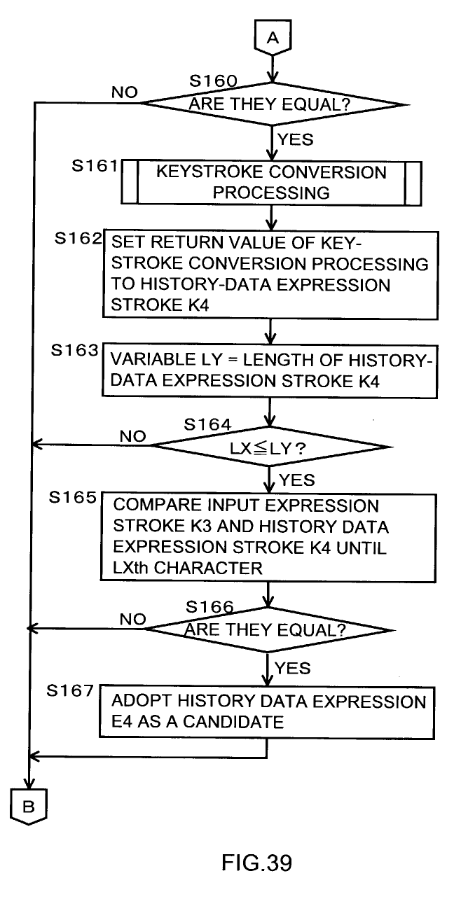

FIGS. 38 and 39 illustrates a flowchart of the candidate-obtaining processing in the fifth embodiment. The candidate-obtaining processing unit 16 sets the length of the input expression E3 to the variable L (step S151). The L−1 th character of the input expression E3 is passed to the keystroke conversion processing unit 14 as an input parameter, and the keystroke conversion processing is performed (step S152). The return value of the keystroke conversion processing is set to the input expression stroke K3 (step S153). The length of the input expression stroke K3 is set to a variable LX (step S154). The storage processing unit 12 fetches an expression e from the history-data storage unit 13, and sets it to the history data expression E4 (step S155). If there is data in the history data expression E4 (step S156), the candidate-obtaining processing unit 16 sets the length of the history data expression E4 to a variable M (step S157). If the variable L is equal to or less than the variable M (step S158), a comparison is made between the input expression E3 and the history data expression E4 as far as L−1 characters. If L=1, the input expression E3 and the history data expression E4 are regarded as equal (step S159). If both of them are equal (step S160), L−1 th one character of the history data expression E4 or all characters following this are passed to the keystroke conversion processing unit 14 as an input parameter, and the keystroke conversion processing is performed (step S161). The return value of the keystroke conversion processing is set to the input expression stroke K4 (step S162). The length of the input expression stroke K4 is set to a variable LY (step S163). If the variable LY is equal to the variable LX or more (step S164), a comparison is made between the input expression stroke K3 and the history data expression stroke K4 until LX the characters (step S165). If both of them are equal (step S166), the history data expression E4 is adopted as a candidate (step S167). Thereafter until the history data expression E4 has data (step S156), the processing from step S157 to step S167 is repeated. If there is no data, the processing is terminated.

In the following, a sixth embodiment will be described. The input prediction processing device 1 can perform input prediction processing in the so-called pin-yin method character input processing which is generally carried out in input processing of expressions in Chinese language. The pin-yin method is an input method in which a plurality of alphabet characters are assigned to each numeric key as in the input unit 2, and a character to be input changes by the number of keystrokes. In this case, keystroke conversion is performed, for example, using the same table as the keystroke conversion table 45 as shown in FIG. 33. For example, a keystroke data string for inputting the reading “LIXUE” of the expression “RIKIGAKU” becomes “44433388877722”.

In this regard, in order to simplify the description, in the description of the following pin-yin method input, all the input characters are in capital letters, and tonal signs are omitted.

In the present embodiment, an input prediction processing device 1 is the same as the configuration example of the input prediction processing device 1 described in the first embodiment, and extracts candidates of the input prediction by performing various processing described from the first to the third embodiments.

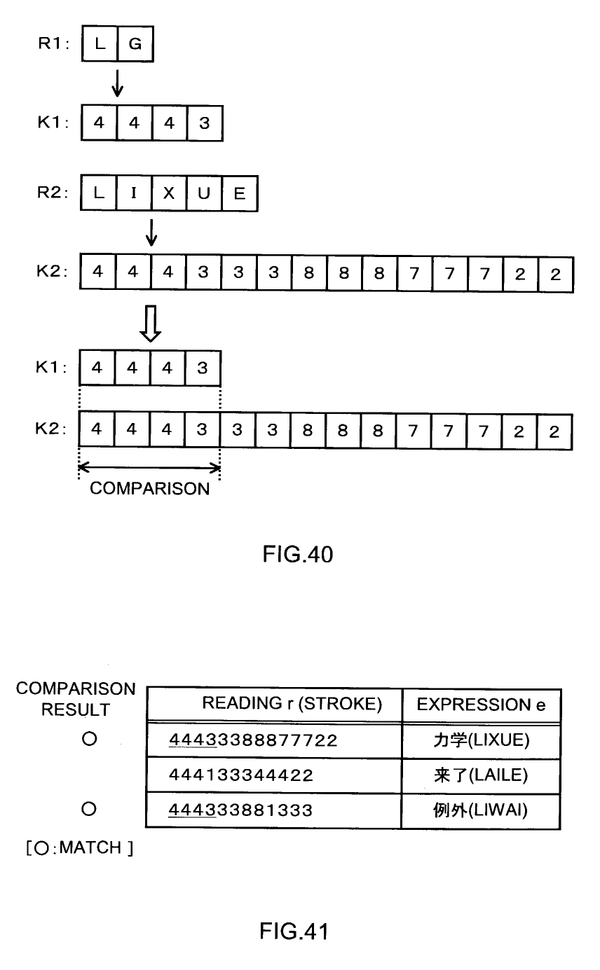

The storage processing unit 12 stores the input reading “LIXUE” entered by the pin-yin method in the input unit 2 or the reading keystroke data string “44433388877722”, and the determined expression “RIKIGAKU” in the history-data storage unit 13 as history data. Thereafter, suppose, for example, as shown in FIG. 40, in the candidate-obtaining processing, in the input unit 2, a reading “L” is entered, and subsequently a “3” key is pressed three times for “I”. The storage processing unit 12 receives “L, G” and sets it to the input reading R1 “LG”. Also, the storage processing unit 12 sets the expression e “LIXUE” from the history-data storage unit 13 to the history data reading R2, and sets the expression e “RIKIGAKU” to the expression E1. Thereafter, the candidate-obtaining processing unit 16 compares the input-reading keystroke K1 “4443”, which is keystroke converted from the input reading R1, and the history-data reading keystroke K2 of the same length as the input-reading keystroke K1 “44433388877722”, which is keystroke converted from the history data reading R2, and if they are forward-matched, the expression E1 “RIKIGAKU” is adopted as a candidate.

Suppose that, for example, a combination of a reading r (stroke) and an expression e as shown in FIG. 41 is stored in the history-data storage unit 13 as his data. The candidate-obtaining processing unit 16 adopts the expressions “RIKIGAKU, REIGAI” of the reading r (stroke) which is forward-matched with the input-reading keystroke K1 “4443” as a result of the comparison processing.

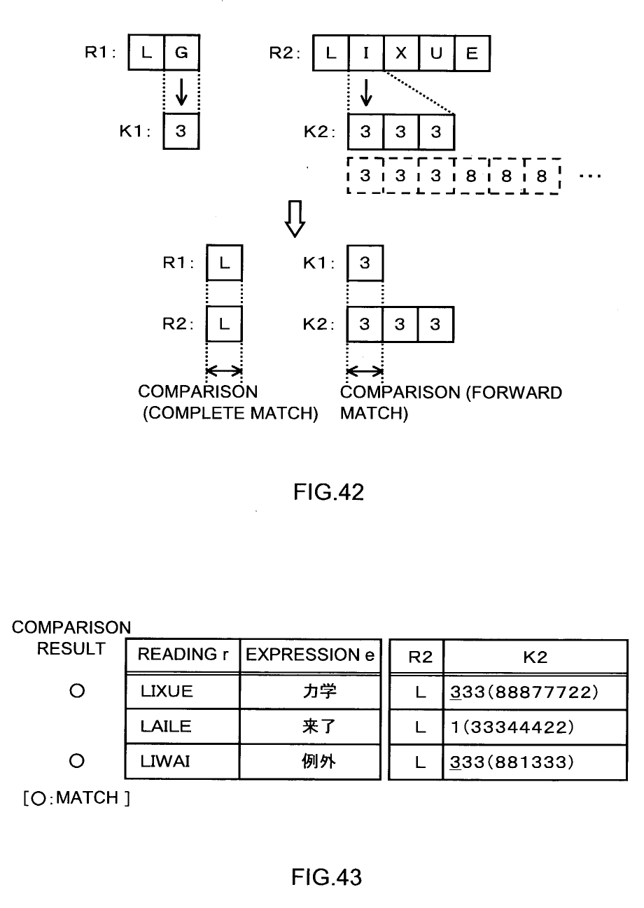

Also, as shown in FIG. 42, the candidate-obtaining processing unit 16 compares the input reading R1 “LG” as far as one character before the last “L” and as far as the character “L” of the same position of the character taken as in the input reading R1 from the history data reading R2 “LIXUE”, and determines whether they are completely matched. Then if they are completely matched, the storage processing unit 12 sets the keystroke converted value “3” from the last character “G” of the input reading R1 “LG” to the input-reading keystroke K1, and the keystroke converted value “333” from the character “I” (or the character following “I”) corresponding to the “G” position of the input reading R1 of the history data reading R2 “LIXUE” to the history-data reading keystroke K2. Thereafter, the candidate-obtaining processing unit 16 compares the input-reading keystroke K1 “3” and the history-data reading keystroke K2 “333” (or “3338887722”) of the same length as the input-reading keystroke K1, and if they are forward-matched, the expression E1 is adopted as a candidate.

Suppose that history data (combination of reading r and expression e) as shown in FIG. 43 is stored in the history-data storage unit 13, and a reading “LG” is entered from the input unit 2. In this case, it is determined whether or not the beginning character “L” of the input reading R1 and the character (reading) of the history data reading R2 corresponding to this beginning character “L” are matched. For the beginning character “L” of the input reading R1, all the reading r are matched.

Further, the candidate-obtaining processing unit 16 compares input-reading keystroke K1 “3” of “G” of the input reading R1 “LG” and the history-data reading keystroke K2 corresponding to the character “I”, and selects the expression e's, “LIXUE, LIWAI” corresponding to the history-data reading keystroke K2 which are forward matched, as two candidates.

The present invention has been described using some embodiments thus far, however, the present invention can have various variations within the spirit and scope of the present invention. For example, in the embodiments of the present invention, the keystroke conversion processing unit converts an input reading, etc. to a keystroke data string with reference to a keystroke conversion table. However, a character string such as an input reading, etc. may be converted to a keystroke data string using an operation processing.

What is claimed is:

1. A program for input prediction processing on a computer which includes a history-data storage unit for storing a previously input reading and expression related to the reading as a history data and displays an expression corresponding to a reading extracted from the history-data storage unit when a subsequent reading is entered, the program causing the computer to execute:
storage processing which stores history-data reading keystroke information representing a reading as a history-data reading in the history-data storage unit; and
candidate-obtaining processing which obtains input-reading keystroke information representing a subsequent input reading, compares the input-reading keystroke information with the history-data reading keystroke information of each history-data reading from the beginning part, and, selects, as an input prediction candidate, the expression corresponding to the history-data reading keystroke information of which the beginning part is matched with the input-reading keystroke information.

2. A program according to claim 1, wherein, in the storage processing, the program causes the computer to execute processing which obtains an input-reading keystroke data string at actual input time, and sets it as the reading keystroke information.

3. A program according to claim 1, wherein, in the storage processing, the program causes the computer to execute processing which generates the keystroke data string from the input reading and sets it to the reading keystroke information based on conversion information defining a corresponding relationship between a reading and keystrokes.

4. A program according to claim 1, wherein, in the storage processing, the program causes the computer to execute processing which stores a keystroke data string including input-position shift information indicating a shift of an input position as input-reading keystroke information or history-data reading keystroke information when input-position shift information is included in the input reading or in the history-data reading.

5. A program according to claim 4, wherein, in the candidate-obtaining processing, the program causes the computer to execute processing which adds a keystroke value immediately before the input-position shift information at the end of the keystroke data string, when either end of the input-reading keystroke information or the history-data reading keystroke information is input-position shift information.

6. A program for input prediction processing on a computer which includes a history-data storage unit for storing a previously input reading and expression related to the reading as a history data and displays an expression corresponding to a reading in history data extracted from the history-data storage unit when a subsequent reading is entered, the program causing the computer to execute:
storage processing which stores a reading character string representing the history-data reading in the history-data storage unit; and
candidate-obtaining processing which obtains input-reading keystroke information representing a subsequent reading as a keystroke data string, obtains history-data reading keystroke information representing the history-data reading as a keystroke data string, compares the input-reading keystroke information with the history-data reading keystroke information of every history-data reading from the beginning part, and, selects, as an input prediction candidate, an expression corresponding to the history-data reading keystroke information of which the beginning part is forward-matched the input-reading keystroke information.

7. A program according to claim 6, wherein, in the candidate-obtaining processing, the program causes the computer to execute processing which obtains input-reading keystroke information representing the last character of a subsequent input reading when the character string as far as one character before the last character of the input reading matches a character string of the history-data readings corresponding to the character string of the input reading;
obtains history-data stroke information representing a keystroke data string corresponding the last character of the input reading from the history-data reading; and
adopts an expression corresponding to the history-data reading as a candidate when the input-reading keystroke information matches a beginning part of the history-data reading keystroke information.

8. A program according to claim 6, wherein, in the candidate-obtaining processing, the program causes the computer to execute processing which, when the end of the obtained input-reading keystroke information or the history-data reading keystroke information is input-position shift information, adds a keystroke value immediately before the input-position shift information at the end of the keystroke data string.

9. A program for input prediction processing on a computer which includes a history-data storage unit for storing a previously input expression as a history data and displays an expression corresponding to a subsequent input expression from the history-data storage unit when a subsequent expression is entered, the program causing the computer to execute:
storage processing which stores the expression character string representing the expression in the history-data storage unit; and
candidate-obtaining processing which obtains input expression keystroke information representing the input expression by a keystroke data string, obtains history-data expression keystroke information representing the expression in the history-data storage unit, compares the input expression keystroke information with the history-data expression keystroke information of each expression from the beginning part, and selects the expression corresponding to the history data expression keystroke information of which the beginning part is forward-matched with the input expression keystroke information.

10. A program according to claim 9, wherein, in the candidate-obtaining processing, the program causes the computer to execute processing which obtains input expression keystroke information representing the last character of the subsequent input expression when the character string as far as one character before the last character of the input expression matches a reading character string of the history-data expression corresponding to the character string of the input expression,
obtains history-data keystroke information representing a keystroke data string corresponding the last character of the input expression from the history data, and
adopts an expression corresponding to the history-data reading as a candidate when the input expression keystroke information matches a beginning part of the history-data expression keystroke information.

11. A program according to claim 9, wherein, in the storage processing, the program causes the computer to execute processing which, when input-position shift information indicating a shift of an input position is included in the obtained input expression or the history-data expression, adds a keystroke value immediately before the input-position shift information at the end of the keystroke data string.

12. A method for input prediction processing on a computer which includes a history data storage unit for storing a previously input reading and expression related to the reading as a history data and displays an expression corresponding to a reading of history data extracted from the history-data storage unit when a subsequent reading is entered, the method comprising the steps of:
storing history-data reading keystroke information representing an input reading as history-data reading in the history-data storage unit; and
obtaining input-reading keystroke information representing an input keystroke data string from a subsequent input reading, comparing the input-reading keystroke information with the reading keystroke information of every history-data reading, and selecting, as an input prediction candidate, the expression corresponding to the history-data reading keystroke information of which the beginning part is matched with the input-reading keystroke information.

13. A method for input prediction processing on a computer which includes a history data storage unit for storing a previously input reading and expression related to the reading as a history data and displays an expression corresponding to a reading of history data extracted from the history-data storage when a subsequent reading is entered, the method comprising the steps of:
storing an input reading character string representing the history-data reading in the history-data storage unit; and
obtaining input-reading keystroke information representing a subsequent reading as a keystroke data string, obtaining history-data reading keystroke information representing the history-data reading as a keystroke data string, comparing the input-reading keystroke information with the history-data reading keystroke information of each history-data reading from the beginning part, and selecting, as an input prediction candidate, an expression corresponding to the history-data reading keystroke information of which the beginning part of is matched with the input-reading keystroke information.

14. A method for input prediction processing on a computer which includes a history data storage unit for storing a previously input expression as a history data and displays an expression corresponding to a reading of history data extracted from the history-data storage unit when a subsequent expression is entered, the method comprising the steps of:
storing the expression character string representing the expression in the history-data storage; and
obtaining input expression keystroke information representing a subsequent input expression as a keystroke data string, obtaining history-data expression keystroke information representing the expression in the history-data storage unit, comparing the input expression keystroke information with the history-data expression keystroke information from the beginning part, and selecting the expression of the history-data expression keystroke information of which the beginning part is forward-matched the input expression keystroke information.

15. An input prediction processing device which includes a history-data storage unit for storing a previously input reading and expression related to the reading as a history data and displays an expression corresponding to a reading of history data extracted from the history-data storage unit when a subsequent reading is entered, the device comprising:
storage means for storing history-data reading keystroke information representing a reading as history-data reading in the history-data storage unit; and
candidate-obtaining means for obtaining input-reading keystroke information representing a subsequent input reading,
comparing the input-reading keystroke information with the reading keystroke information of each history-data reading from the beginning part, and selecting, as an input prediction candidate, the expression corresponding to the reading keystroke information of which the beginning part is matched with the input-reading keystroke information.

16. An input prediction processing device which includes a history-data storage unit for storing a previously input reading and expression related with the reading as history data and displays an expression corresponding to a reading of history data extracted from the history-data storage unit when a subsequent reading is entered, the device comprising:
storage means for storing a reading character string representing a history-data reading in the history-data storage unit; and
candidate-obtaining means for obtaining input-reading keystroke information representing a subsequent reading as a keystroke data string, obtaining history-data reading keystroke information representing the reading of the history data by a keystroke data string, comparing the input-reading keystroke information with the history-data reading keystroke information from the beginning part, and selecting, as an input prediction candidate, the expression corresponding to the history-data reading keystroke information of which the beginning part is forward-matched with the input-reading keystroke information.

17. An input prediction processing device which includes a history-data storage unit for storing a previously input expression as a history data and displays an expression corresponding to a reading of history data extracted from the history-data storage unit when a subsequent expression is entered next time, the device comprising:
storage means for storing the expression character string representing the input expression in the history-data storage unit; and
candidate-obtaining means for obtaining input expression keystroke information representing a subsequent input expression by a keystroke data string, obtaining history-data expression keystroke information representing the expression of the history data,
comparing the input expression keystroke information with the history-data expression keystroke information of each expression from the beginning part, and selecting the expression of the history-data expression keystroke information of which the beginning part is forward-matched with the input expression keystroke information.

18. A recording medium for recording a program for input prediction processing on a computer which includes a history-data storage unit for storing a previously input reading and expression related to the reading as a history data and displays an expression corresponding to a reading of history data extracted from the history-data storage unit when a subsequent reading is entered, the program causing the computer to execute:
storage processing which stores history-data reading keystroke information representing a reading as a history-data reading in the history-data storage unit; and
candidate-obtaining processing which obtains input-reading keystroke information representing a subsequent input reading, compares the input-reading keystroke information with the history-data reading keystroke information of each history-data reading from the beginning part, and, selects, as an input prediction candidate, the expression corresponding to the history-data reading of which the beginning part is matched with the input-reading keystroke information.

19. A recording medium for recording a program for input prediction processing on a computer which includes a history-data storage unit for storing a previously input reading and expression related to the reading as a history data and displays an expression corresponding to a reading of history data extracted from the history-data storage unit when a subsequent reading is entered, the program causing the computer execute:
storage processing which stores a reading character string represent the history-data reading in the history-data storage unit; and
candidate-obtaining processing which obtains input-reading keystroke information representing a subsequent reading as a keystroke data string, obtains history-data reading keystroke information representing the history-data reading as a keystroke data string, compares the input-reading keystroke information with the history-data reading keystroke information of every history-data reading from the beginning part, and, selects, as an input prediction candidate, an expression corresponding to the history-data reading keystroke information of which the beginning part is forward-matched the input-reading keystroke information.

20. A recording medium for recording a program for input prediction processing on a computer which includes a history-data storage unit for storing a previously input expression as a history data and displays an expression corresponding to a reading of history data extracted from the history-data storage unit when a subsequent expression is entered, the program causing the computer execute:
storage processing which stores the expression character string representing the expression in the history-data storage unit; and
candidate-obtaining processing which obtains input expression keystroke information representing the input expression by a keystroke data string, obtains history-data expression keystroke information representing the expression in the history-data storage unit, compares the input expression keystroke information with the history-data expression keystroke information of each expression from the beginning part, and selects the expression corresponding to the history data expression keystroke information of which the beginning part is forward-matched with the input expression keystroke information.
